(19) United States
(12) Patent Application Publication
(10) Pub. No.: US 2007/0078185 A1
(43) Pub. Date: Apr. 5, 2007

(54) Methods and compositions for controlling invertebrate pests

(76) Inventors: H. Robert Horvitz, Auburndale, MA (US); Mark J. Alkema, Cambridge, MA (US)

Correspondence Address: CLARK & ELBING LLP, 101 FEDERAL STREET, BOSTON, MA, 02110, US

(21) Appl. No.: 11/409,634

(22) Filed: Apr. 24, 2006

Related U.S. Application Data
(60) Provisional application No. 60/673,829, filed on Apr. 22, 2005.

(51) Int. Cl. A01N 37/44; A01N 33/02; A01N 37/12

(52) U.S. Cl. 514/567; 514/649

(57) ABSTRACT

The invention features methods for controlling invertebrate pests using compositions that disrupt tyrosine decarboxylase activity.

### CROSS-REFERENCE TO RELATED APPLICATIONS

This application claims the benefit of U.S. Provisional Application No. 60/673,829, filed Apr. 22, 2005, which is incorporated herein by reference.

### BACKGROUND OF THE INVENTION

The invention relates to methods for controlling invertebrate pests.

Biogenic amines play pivotal roles in the control of animal behavior. The biogenic amine octopamine can act as a neurotransmitter in invertebrates and is considered the invertebrate counterpart to norepinephrine. Octopamine has been implicated in several physiological processes, including light emission by fireflies (Nathanson, J. A., Science 203:65-68 (1979)), foraging behavior (Barron et al., J Comp. Physiol. A Neuroethol. Sens. Neural Behav. Physiol. 188:603-610 (2002)), the sting response of honey bees (Burrell et al., J Insect. Physiol. 41:671-680 (1995)), the fight or flight response of locusts (Orchard et al., A. Rev. Ent. 38:227-249 (1993)), associative learning by fruit flies and honey bees (Hammer et al., Learn. Mem. 5:146-156 (1998); and Schwaerzel et al., J Neurosci 23:10495- 10502 (2003)), and ovary muscle contraction in locusts and fruit flies (Orchard et al., J. NeurobioL 16:171-181 (1985); Lee et al., Dev. Biol. 264:179-190 (2003); and Monastirioti, M., Dev. Biol. 264:38-49 (2003)).

Octopamine biosynthesis requires tyrosine decarboxylase to convert tyrosine into tyramine and tyramine beta-hydroxylase to convert tyramine into octopamine. The physiological role of tyramine, the biosynthetic precursor of octopamine, has been relatively unexplored (Roeder et al., Arch. Insect Biochem. Physiol. 54:1-13 (2003)). Tyramine was initially thought to be simply a precursor octopamine. However, the identification of G-protein coupled receptors in Drosophila (Saudou et al., EMBO J. 9:3611-3617 (1990)), the locust (Vanden Broeck et al., J Neurochem. 64:2387-2395 (1995)), the honey bee (Blenau et al., J. Neurochem. 74:900-908 (2000)), the silk moth (Ohta et al., Insect Mol. Biol 12:217-223 (2003)).and C. elegans (Rex et al., J. Neurochem. 82:1352-1359 (2002)) that respond to tyramine suggested that tyramine may itself act as a neurotransmitter.

A better understanding of the physiological role of tyramine and tyraminergic signaling components in invertebrates can lead to new invertebrate-specific methods of controlling invertebrate pests.

### SUMMARY OF THE INVENTION

A method of controlling an insect, nematode, or other invertebrate population is provided by the invention. The method involves contacting an invertebrate with an invertebrate tyrosine decarboxylase inhibitor in an amount sufficient to kill, incapacitate, or prevent reproduction by the invertebrate (e.g., insects or nematodes). The inhibitors may also be prophylactically applied to a site or organism to prevent infestation or infection by an invertebrate.

In a first aspect, the invention features a method of inhibiting proliferation of an insect at a site by contacting the site with a tyrosine decarboxylase inhibitor in an amount sufficient to inhibit the proliferation. The site can be, for example, on a plant, in or on an animal, or in a dwelling (e.g., a home).

In one embodiment of the above aspect, the insect is a beetle, grasshopper, locust, wasp, bee, mosquito, fly, midge, ant, cotton leaf perforator, flea, roach, termite, aphid, scale, mite, nematode, arachnid, or moth. Desirably, the invertebrate is a parasitic nematode.

In a related aspect, the invention features a method of inhibiting proliferation of an invertebrate at a site by contacting the site with a tyrosine decarboxylase inhibitor in an amount sufficient to inhibit the proliferation, wherein the inhibitor is a compound of formula I: 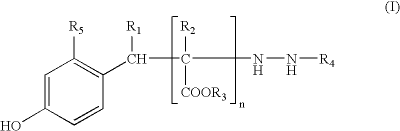
wherein n is 0 or 1; each of R₁, R₂, and R₃ is, independently, selected from H, C₁₋₄ alkyl, C₂₋₄ alkenyl, C₂₋₄ alkynyl, and C₁₋₄ heteroalkyl; R4 is selected from H and acyl; and R₅ is H, F, or OH.

In one embodiment of the above aspect, the invertebrate is a beetle, grasshopper, locust, wasp, bee, mosquito, fly, midge, ant, cotton leaf perforator, flea, roach, termite, aphid, scale, mite, nematode, arachnid, or moth. Desirably, the invertebrate is a parasitic nematode.

The invention also features a compound of formula I: 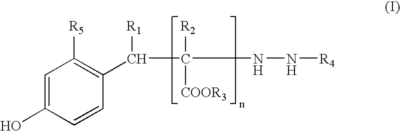
wherein n is 0 or 1; each of R₁, R₂, and R₃ is, independently, selected from H, C₁₋₄ alkyl, C₂₋₄ alkenyl, C₂₋₄ alkynyl, and C₁₋₄ heteroalkyl; R₄ is selected from H and acyl; and R₅ is H, F, or OH.

The invention further features a composition for inhibiting the proliferation of invertebrates including a compound of formula I, or a suitable salt thereof, together with a diluent or dispersant. Suitable diluents and dispersants include, without limitation, Solvesso™, dipropylene glycol monomethyl ether, and N-methyl-pyrrolidone. The composition can be in the form of, for example, a spray, dust, granular material, a suspension, emulsion, pellet, or wettable powder.

The invention also features a kit including (i) a tyrosine decarboxylase inhibitor of the invention, or a salt thereof, and (ii) instructions for delivering the inhibitor to a site infested, or at risk of infestation, by an invertebrate population..

The invention further features a pharmaceutical composition including a tyrosine decarboxylase inhibitor of the invention, or a salt thereof, together with a pharmaceutically acceptable excipient.

In a related aspect, the invention features a method for identifying an inhibitor of invertebrate tyrosine decarboxylase. The method includes the steps of (i) contacting invertebrate tyrosine decarboxylase with tyrosine in the presence of a candidate compound; and (ii) monitoring the conversion of tyrosine to tyramine. In one embodiment, the tyrosine is labeled, e.g., radiolabeled. This method may be performed in vivo or in vitro, for example, in a high throughput cell-free assay.

In a certain embodiment of any of the above aspects, the compound of formula (I) is (2S)-2-(3-hydroxybenzyl)-2-hydrazinopropanoic acid, N-(DL-seryl)- N′-(2,4,-dihydroxybenzyl) hydrazine, or 4-hydrazinomethyl-benzene- 1,3-diol.

By “tyrosine decarboxylase” is meant an enzyme which is naturally occurring in an invertebrate and which catalyzes the in vivo conversion of L-tyrosine into tyramine. Tyrosine decarboxylases include, for example, Drosophila CG30446 protein and mosquito CP3581 protein.

By “tyrosine decarboxylase inhibitor” is meant a compound that can reduce the rate of conversion of tyrosine to tyramine by tyrosine decarboxylase by at least 20%, 30%, 40%, 50%, 60%, 70%, 80%, 90%, 95%, or even 99% in comparison to the conversion rate in the absence of the inhibitor. Tyrosine decarboxylase inhibitors of the invention can bind to TDC- 1 with an affinity of less than 10 μM, 1 μM, or even 500 nM under physiological conditions.

As used herein, “biocide” refers to a compound which inhibits tyrosine decarboxylase and slows, delays, inhibits, or arrests the growth or reproduction of any invertebrate by at least 10%, 20%, 30%, 40%, 50%, 60%, or even by as much as 70%, 80%, 90%, 95%, or 99% in comparison to growth or reproduction in the absence of the biocide.

By “an amount sufficient” is meant the amount of a tyrosine decarboxylase inhibitor required to inhibit or arrest the growth of an invertebrate, inhibit reproduction in an invertebrate, prevent or deter infestation of a site by an invertebrate, or repel an invertebrate. A sufficient amount of tyrosine decarboxylase inhibitor used to practice the present invention for controlling invertebrate pests varies depending upon a number of factors, including, the invertebrate being controlled, the tyrosine decarboxylase being inhibitor used, the formulation used, and the site to which the inhibitor is applied. In preferred embodiments, the invertebrate pest is an insect. A dose-response curve, as described in the experimental results, can be used to determine a sufficient amount for any particular combination of factors.

As used herein, “inhibiting proliferation” refers to the application of tyrosine carboxylase inhibitor to either an invertebrate population or to a site at risk of infestation by an invertebrate population. Proliferation is inhibited when there is a reduction in invertebrate population growth rate in the presence of a tyrosine decarboxylase inhibitor in comparison to the growth rate observed for the same conditions in the absence of a tyrosine decarboxylase inhibitor.

By “parasitic nematode” is meant any nematode that lives on or within the cells, tissues, or organs of a genetically distinct host organism (e.g., plant or animal). For example, parasitic nematodes include, but are not limited to, any ascarid, filarid, or rhabditid (e.g., Onchocerca volvulus, Ancylostoma, Ascaris, Ascaris lumbricoides, Ascaris suum, Baylisascaris, Baylisascaris procyonis, Brugia malayi, Dirofilaria, Dirofilaria immitis, Dracunculus, Haemonchus contortus, Heterorhabditis bacteriophora, Loa loa, root-knot nematodes, such as Meloidogyne, M. arenaria,, M. chitwoodi, M. graminocola, M. graminis, M. hapla, M. incognita, Necator, M. microtyla, and M. naasi, cyst nematodes (for example, Heterodera sp. such as H. schachtii, H. glycines, H. sacchari, H. oryzae, H. avenae, H. cajani, H. elachista, H. goettingiana, H. graminis, H. mediterranea, H. mothi, H. sorghi, and H. zeae, or, for example, Globodera sp. such as G. rostochiensis and G. pallida) root-attacking nematodes (for example, Rotylenchulus reniformis, Tylenchuylus semipenetrans, Pratylenchus brachyurus, Radopholus citrophilus, Radopholus similis, Xiphinema americanum, Xiphinema rivesi, Paratrichodorus minor, Heterorhabditis heliothidis, and Bursaphelenchus xylophilus), and above-ground nematodes (for example, Anguina funesta, Anguina tritici, Ditylenchus dipsaci, Ditylenchus myceliphagus, and Aphenlenchoides besseyi), Parastrongyloides trichosuri, Pristionchus pacificus, Steinernema, Strongyloides stercoralis, Strongyloides ratti, Toxocara canis, Trichinella spiralis, Trichuris muris or Wuchereria bancrofti).

By “ortholog” is meant any polypeptide of an organism that is highly related to a reference protein or nucleic acid sequence from another organism. The degree of relatedness may be expressed as the probability that a reference protein would identify a sequence, for example, in a blast search. The probability that a reference sequence would identify a random sequence as an ortholog is ext4remely low, less than e⁻¹⁰,e⁻²⁰, e⁻³⁰, e⁻⁴⁰, e⁻⁵⁰, e⁻⁷⁵, e⁻¹⁰⁰. The skilled artisan understands that an ortholog is likely to be functionally related to the reference protein or nucleic acid sequence. In other words, the ortholog and its reference molecule would be expected to fulfill similar, if not equivalent, functional roles in their respective organisms.

By “substantially identical” is meant a polypeptide exhibiting at least 30% identity to a reference amino acid sequence (for example, any one of the amino acid sequences described herein). Preferably, such a sequence is at least 40%, more preferably 50%, and most preferably 60% or even 75% identical to the sequence used for comparison.

Sequence identity is typically measured using sequence analysis software (for example, Sequence Analysis Software Package of the Genetics Computer Group, University of Wisconsin Biotechnology Center, 1710 University Avenue, Madison, WI 53705, BLAST, BESTFIT, GAP, or PILEUP/PRETTYBOX programs). Such software matches identical or similar sequences by assigning degrees of homology to various substitutions, deletions, and/or other modifications. Conservative substitutions typically include substitutions within the following groups: glycine, alanine; valine, isoleucine, leucine; aspartic acid, glutamic acid, asparagine, glutamine; serine, threonine; lysine, arginine; and phenylalanine, tyrosine. In an exemplary approach to determining the degree of identity, a BLAST program may be used, with a probability score between e⁻³ and e⁻¹⁰⁰ indicating a closely related sequence.

In the generic descriptions of compounds of this invention, the number of atoms of a particular type in a substituent group is generally given as a range, e.g., an alkyl group containing from 1 to 4 carbon atoms or C₁₋₄ alkyl. Reference to such a range is intended to include specific references to groups having each of the integer number of atoms within the specified range. For example, an alkyl group from 1 to 4 carbon atoms includes each of C₁, C₂, C₃, and C₄. A C₁₋₄ heteroalkyl, for example, includes from 1 to 3 carbon atoms in addition to one or more heteroatoms. Other numbers of atoms and other types of atoms may be indicated in a similar manner.

As used herein, the terms “alkyl” and the prefix “alk-” are inclusive of both straight chain and branched chain groups and of cyclic groups, i.e., cycloalkyl. Cyclic groups can be monocyclic or polycyclic and preferably have from 3 to 4 ring carbon atoms, inclusive. Exemplary cyclic groups include cyclopropyl and cyclobutyl groups. The C₁₋₄ alkyl group may be substituted or unsubstituted. Exemplary substituents include alkoxy, aryloxy, sulfhydryl, alkylthio, arylthio, halide, hydroxyl, fluoroalkyl, perfluoralkyl, cyano, nitrilo, NH-acyl, amino, aminoalkyl, disubstituted amino, quaternary amino, hydroxyalkyl, carboxyalkyl, and carboxyl groups. C₁₋₄- alkyls include, without limitation, methyl; ethyl; n-propyl; isopropyl; cyclopropyl; cyclopropylmethyl; n-butyl; iso-butyl; sec-butyl; tert-butyl; and cyclobutyl.

By “C₂₋₄ alkenyl” is meant a branched or unbranched hydrocarbon group containing one or more double bonds and having from 2 to 4 carbon atoms. A C₂₋₄ alkenyl may optionally include monocyclic or polycyclic rings, in which each ring desirably has from three to four members. The C₂₋₄ alkenyl group may be substituted or unsubstituted. Exemplary substituents include alkoxy, aryloxy, sulfhydryl, alkylthio, arylthio, halide, hydroxyl, fluoroalkyl, perfluoralkyl, cyano, nitrilo, NH-acyl, amino, aminoalkyl, disubstituted amino, quaternary amino, hydroxyalkyl, carboxyalkyl, and carboxyl groups. C₂₋₄ alkenyls include, without limitation, vinyl; allyl; 2-cyclopropyl-1-ethenyl; 1-propenyl; 1-butenyl; 2-butenyl; 3-butenyl; 2-methyl-1-propenyl; and 2-methyl-2-propenyl.

By “C₂₋₄ alkynyl” is meant a branched or unbranched hydrocarbon group containing one or more triple bonds and having from 2 to 4 carbon atoms. The C₂₋₄ alkynyl group may be substituted or unsubstituted. Exemplary substituents include alkoxy, aryloxy, sulfhydryl, alkylthio, arylthio, halide, hydroxy, fluoroalkyl, perfluoralkyl, cyano, nitrilo, NH-acyl, amino, aminoalkyl, disubstituted amino, quaternary amino, hydroxyalkyl, carboxyalkyl, and carboxyl groups. C₂₋₄ alkynyls include, without limitation, ethynyl, 1-propynyl, 2-propynyl, 1-butynyl, 2-butynyl, and 3-butynyl.

By “C₁₋₄ heteroalkyl” is meant a branched or unbranched alkyl, alkenyl, or alkynyl group having from 1 to 4 carbon atoms in addition tol, 2, 3 or 4 heteroatoms independently selected from the group consisting of N, 0, S, and P. Heteroalkyls include, without limitation, tertiary amines, secondary amines, ethers, thioethers, amides, thioamides, carbamates, thiocarbamates, hydrazones, imines, phosphodiesters, phosphoramidates, sulfonamides, and disulfides. A heteroalkyl may optionally include monocyclic, bicyclic, or tricyclic rings, in which each ring desirably has three to six members. The heteroalkyl group may be substituted or unsubstituted. Exemplary substituents include alkoxy, aryloxy, sulfhydryl, alkylthio, arylthio, halide, hydroxyl, fluoroalkyl, perfluoralkyl, cyano, nitrilo, NH-acyl, amino, aminoalkyl, disubstituted amino, quaternary amino, hydroxyalkyl, hydroxyalkyl, carboxyalkyl, and carboxyl groups. Examples of C1-8 heteroalkyls include, without limitation, methoxymethyl and ethoxyethyl.

By “halide” is meant bromine, chlorine, iodine, or fluorine.

By “fluoroalkyl” is meant an alkyl group that is substituted with a fluorine.

By “perfluoroalkyl” is meant an alkyl group consisting of only carbon and fluorine atoms.

By “carboxyalkyl” is meant a chemical moiety with the formula -(R)- COOH, wherein R is selected from C₁₋₄ alkyl, C₂₋₄ alkenyl, C₂₋₄ alkynyl, or C₁₋₄ heteroalkyl.

By “hydroxyalkyl” is meant a chemical moiety with the formula -(R)-OH, wherein R is selected from C₁₋₄ alkyl, C₂₋₄ alkenyl, C₂₋₄ alkynyl, or C₁₋₄ heteroalkyl.

By “alkoxy” is meant a chemical substituent of the formula -OR, wherein R is selected from C₁₋₄ alkyl, C₂₋₄ alkenyl, C₂₋₄ alkynyl, or C₁₋₄ heteroalkyl.

By “alkylthio” is meant a chemical substituent of the formula -SR, wherein R is selected from C₁₋₄ alkyl, C₂₋₄ alkenyl, C₂₋₄ alkynyl, or C₁₋₄ heteroalkyl.

By “quaternary amino” is meant a chemical substituent of the formula -(R)- N(R′)(R″)(R′″)+, wherein R, R′, R″, and R′″ are each independently an alkyl, alkenyl, or alkynyl group. R may be an alkyl group linking the quaternary amino nitrogen atom, as a substituent, to another moiety. The nitrogen atom, N, is covalently attached to four carbon atoms of alkyl and/or aryl groups, resulting in a positive charge at the nitrogen atom.

By “acyl” is meant a chemical moiety with the formula R-C(O)-, wherein R is selected from C₁₋₄ alkyl, C₂₋₄ alkenyl, C₂₋₄ alkynyl, C₁₋₄ heteroalkyl, or amino acid acyl.

By “amino acid acyl” is meant a chemical moiety with the formula R-C(O)-, wherein R-C(O)- is selected from natural and unnatural α, β, and γ amino acids, including, for example, N-alkylated amino acids, and natural amino acids, such as alanine, serine, and glycine, among others.

Applicants have discovered genes encoding tyrosine decarboxylase which are present in invertebrates and necessary for the in vivo conversion of tyrosine to tyramine. The compounds of the invention, which can act as tyrosine decarboxylase inhibitors and block the biosynthesis of tyramine, are useful for controlling the proliferation of invertebrates.

### BRIEF DESCRIPTION OF THE DRAWINGS

FIGS. 1A-1C depict the proteins and genes that function in the octopamine biosynthetic pathway. FIG. 11A shows the octopamine biosynthetic pathway. Octopamine biosynthesis requires two enzymes: a tyrosine decarboxylase that converts tyrosine into tyramine, and a tyramine P-hydroxylase that converts tyramine into octopamine. FIG. 1B shows the gene structure of tbh-1 as derived by comparing genomic and cDNA sequences. Coding sequences are represented by black boxes; untranslated regions are represented by white boxes. The SLI trans-spliced leader and the poly(A) tail are indicated. In the tbh-1 (n3247) mutant allele 791 bp are deleted. This deletion removed parts of exon 6 and exon 7, and caused a frameshift that leads to a premature truncation of the TBH-1 protein. The tbh-1(n3722) mutant allele contains a 1610 bp in-frame deletion of exons 5, 6 and 7, which causes a 242 amino acid deletion in the encoded protein. The deleted regions are indicated by bars. FIG. 1C shows an alignment of TBH- 1 with Drosophila TBH and human DBH. Solid boxes indicate identities and shaded boxes indicate similarities within TBH-1. The conserved histidine-rich copper binding regions are denoted by black bars. An asterix indicates a potential N-glycosylation site. The open box indicates a putative signal sequence.

FIGS. 2A-2C show that tbh-1 mutants lack octopamine and have increased tyramine levels, while tdc-1 mutants lack both octopamine and tyramine. FIG. 2A shows HPLC traces of wild-type, tbh-1(n3247) and tdc-1(n3420) extracts. FIG. 2B shows a thin layer chromatograph of dansylated derivatives of wild-type, tbh-1(n3247), and tdc-1(n3420) extracts. 50 pmol of dansylated tyramine was used as a standard (TA). The dansylated tyramine spot form worm extracts is circled by a dotted line. Dansylated tyramine is absent in extracts from tdc-1(n3420) mutants. FIG. 2C shows that TDC activity is absent in tdc-1(n3420) mutants. TDC activity was measured by monitoring the conversion of [³ Htyrosine to [³H]tyramine in extracts of wild-type, tdc-1(n3420), tdc-1(n3420); Ex1105, and bas-1(ad446) animals at thirty, sixty and ninety minutes. Tyrosine and tyramine were separated by organic-phase extraction. TDC activity is virtually absent in extracts of tdc-1(n3420) mutants and is rescued by a tdc-1 genomic clone (tdc-1(n3420); nEx1105). Error bars indicate standard deviations.

FIGS. 3A-C show that tdc-1 encodes a tyrosine decarboxylase. FIG. 3A is a phylogenetic analysis of all predicted C. elegans, Drosophila and human aromatic amino acid decarboxylases. Decarboxylases were aligned using ClustalW, and a phylogenetic tree of decarboxylase-conserved regions was determined and the bootstrap analysis and the Unweighted Pair Group Method with Arithmatic Mean (UPGMA). The C. elegans genome contains five aromatic amino acid decarboxylases and a single glutamate decarboxylase, UNC-25. UNC-25 was used as the outgroup. H.m.: Homo sapiens; D.m. Drosophila melanogaster. FIG. 3B depicts the gene structures of tdc-1a and tdc-1b as derived by comparing genomic and cDNA sequences. The tdc-1b transcript uses a cryptic splice-donor site in exon 8. Coding sequences are represented by black boxes and untranslated regions are represented by white boxes. The SLI trans-spliced leader and the poly(A) tail are indicated. The tdc-1(n3419) allele has a 578 bp deletion that removes part of exon 6 and all of exon 7; the tdc-1(n3420) allele has an 803 bp deletion that removes part of exons 3 and 5 and all of exon 4; the tdc-1(n3421) allele has a 585 bp deletion that removes part of exon 4 and exons 5 and 6 in their entirety. The deleted regions are indicated by bars. FIG. 3C is an alignment of TDC- 1A/B with Drosophila DDC and the Drosophila predicted protein CG30446. TDC-1A and TDC-1B differ at their C-termini. Solid boxes indicate identities and shaded boxes indicate similarities with TDC-1. Amino acids that form part of the catalytic core of the enzyme and are essential for decarboxylase finction are denoted by open boxes. The lysine residue required for pyridoxal phosphate binding is denoted by an asterix.

FIGS. 4A-D show TBH- 1 and TDC- 1 protein expression. FIGS. 4A and 4B are Western blot analyses of total protein of (1) the wild type, (2) tdc-1(n3419), (3) tdc-1(n3420), (4) tdc-1(n3421), (5) tbh-1(n3247), (6) tbh-1(n3722) (6) with TBH-1-antibodies (A) and TDC-1-antibodies (B). FIG. 4A shows that TBH-1 antibodies recognize a 70 kDa protein. In the tbh-1(n3722) mutants a 45 kDa band is detected, in agreement with the predicted size of the protein that results from the in-frame deletion of the n3722 allele. TDC-1 antibodies recognize a band around 75 kDa. The weak 60 kDa band in tdc-1(n3419) mutants correlates with the predicted size of the protein present in this in-frame deletion allele. FIGS. 4C and D are photomicrographs showing TBH-1 immunoreactivity in nematode whole-mounts stained with TBH-1 -antibodies. TBH-1 is expressed in the (C) RIC interneurons, where it is mainly localized to synaptic specializations and (D) gonadal sheath cells. (E-F) Whole-mount staining with TDC-1-antisera. TDC-1 is expressed in (E) the UVI cells in the late L4 larva and the (F) gonadal sheath cells in adults. (G-I) Double staining of a tbh-1::gfp transgenic animal with (G) TDC-1-antisera and (H) mouse monoclonal GFP-antibodies. TDC-1 is expressed in the RIM head neurons and the RIC intemeurons. (I) Merged. Anterior is on the left (C-I). Scale bar, 10 μm.

FIGS. 5A-SC are graphs showing that tdc-1 mutant nematodes are hyperactive in egg laying. FIG. 5A shows the number of unlaid eggs in the uterus of wild-type, tbh-1 and tdc-1 nematodes. tdc-1 mutants have fewer eggs in the uterus. Error bars indicate standard errors of the means. FIG. 5B shows the distribution of the stages of freshly-laid eggs in wild type (n=135), tbh-1(n3247) (n=123), tbh-1(n3722) (n-95), tdc-1(n3419) (n=140), and tdc-1(n3420) (n=154) animals. tdc-1 mutants lay eggs at an earlier stage (<8 cells) than do wild-type and tbh-1 animals. FIG. 5C shows that exogenous tyramine inhibits egg laying. Single wild-type animals were transferred to Petri dishes with bacteria containing either no tyramine (n=13) or 20 mM tyramine (n=12). At the indicated times after transfer the number of eggs laid was counted. Error bars indicate standard errors ofthe means.

FIG. 6 shows that tdc-1 mutants fail to suppress head oscillations in response to anterior touch. FIG. 6A depicts the forward locomotion of wild-type nematodes, which is accompanied by oscillatory head movements. Anterior touch of wild-type nematodes with an eyelash induces backing during which head oscillations are suppressed. tdc-1 mutant nematodes fail to suppress head oscillations during backing. FIG. 6B is a table showing the suppression of head oscillations in response to anterior touch scored during backing. FIG. 6C is a table showing that AVM/ALM mechanosensory neurons mediate suppression of head oscillations. Animals were scored for the suppression of head oscillations during spontaneous reversals, in response to gentle anterior or posterior touch, nose touch, harsh touch, octanol and osmotic (4M fructose) avoidance. Animals were scored only if they made at least one backward body bend during a spontaneous reversal or in response to the stimulus. Animals that did not display head oscillations during backward locomotion were scored as positive. Sensory neurons that mediate the responses to the various stimuli are indicated. FIG. 6D is a table showing that animals in which RIM motor neurons or the AVA or AVD backward command neurons were ablated failed to suppress head oscillations in response to anterior touch.

FIGS. 7A-7D shows that tdc-1 mutants and RIM-ablated nematodes have a reduced backing response and an increase in spontaneous reversals. FIG. 7A is a graph showing the distribution in the number of backward body bends in response to anterior touch of wild-type animals (n=279), tbh-1 mutants (tbh-1(n3247), n=92; tbh-1(n3722), n=148) and tdc-1 mutants (tdc-1(n3420), n=244; 1 tdc-1(n3419), n=2320. FIG. 7B is a graph showing the number of spontaneous reversals in 5 minutes of well-fed wild type (n=23), tbh-1(n3247) (n=20), tbh-1(n3722) (n=20), tdc-1(n3420) (n=21), and tdc-1(n3419 (n=23) nematodes on plates devoid of food. FIG. 7C is a graph showing that laser ablations of RIM motor neurons lead to an increase to in the number of spontaneous reversals. Mock (n=12), RIM (n=12), RIC (n=7), AVA (n=7), AVE (n=6), AVD (n=7). Error bars indicate standard errors of the means. FIG. 7D is a schematic diagram of the neural circuit that controls locomotion and head movements. The tyraminergic RIM motor neurons modulate reversal frequency and are required for the suppression of head oscillations. Synaptic connections (arrows) and gap junctions (bars) are as described by White et al., 1986. Excitatory cholinergic motor neurons are represented by green circles; inhibitory GABAergic are represented by red circles. Locomotion command neurons required for the control of forward (AVB, PVC) and backward (AVA, AVD) locomotion are depicted as yellow hexagons. Sensory neurons that detect anterior touch (AVM, ALM) are shown as orange triangles. Hypothesized excitatory inputs (+) and inhibitory (−) connections of neurons in this circuit are based primarily on the identification of neurotransmitters and laser ablation and genetic studies. Connections that are hypothesized to be important for the suppression of head oscillations in response to anterior touch are shown in blue.

FIG. 8 shows an alignment of TDC-1 with orthologous proteins identified via a BLAST search. Drosphila protein CG30446, XP_394424 of the honey bee Apis Mellifera, and XP_308519 of the mosquito Anopheles gambiae were identified as closest homologs of TDC-1. TDC-1 shares 40% identity with Drosophila DDC compared to 50% identity with the Drosophila CG30446 protein and mosquito CP3581 protein, suggesting that CG30446, XP_{—}394424 and XP_{—}308519 are insect tyrosine decarboxylases.

### DETAILED DESCRIPTION

The invention features methods and compositions that disrupt tyrosine decarboxylase activity and are therefore useful biocides.

We identified and characterized a Caenorhabditis elegans tyrosine decarboxylase gene, tdc-1, as well as a tyramine beta-hydroxylase gene, tbh-1. Our findings demonstrate that C. elegans has distinct tyraminergic cells and that tyramine functions independently of octopamine in the Caenorhabditis elegans nervous system. Tyrosine decarboxylase proteins have been identified in the fruit fly, the honey bee and the mosquito. These proteins are closely related to the C. elegans TDC-1 protein. These proteins, inhibited by the methods of the invention, are the insect tyrosine decarboxylases required for tyramine and octopamine biosynthesis. Since tyramine and octopamine are restricted to the invertebrate nervous system, tyraminergic or octopaminergic signaling pathways provide highly specific biocide targets. Tyrosine decarboxylase inhibitors can be used to block the biosynthesis of tyramine in invertebrates and affect invertebrate viability.

Tyrosine Decarboxylase Inhibitors

Tyrosine decarboxylase inhibitors are biocidal agents that can be used to kill, or control the proliferation, of invertebrates. The methods and compositions of the invention are expected to be superior to available biocides, e.g., insecticides and nematicides, due to their very specific mode of action. Because the methods and compositions of the invention specifically target invertebrate proteins, they are less likely to produce adverse effects in mammals and plants to which they are administered.

The tyrosine decarboxylase inhibitor can be, for example, a compound of formula I:

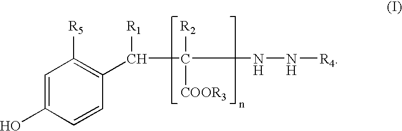

In formula I, n is 0 or 1; each of R₁, R₂, and R₃ is, independently, selected from H, C₁₋₄ alkyl, C₂₋₄ alkenyl, C₂₋₄ alkynyl, and C₁₋₄ heteroalkyl; R₄ is selected from H and acyl; and R₅ is H, F, or OH.

Compounds of formula I can be synthesized using the methods described herein for the synthesis of compounds 1-3, or using, for example, tyrosine and the synthetic protocols provided in U.S. Pat. Nos. 3,462,536 and 3,178,476, each of which is incorporated herein by reference.

Formulation and Use

Tyrosine decarboxylase inhibitors can be formulated for topical and/or systemic application to mammals, field crops, grasses, fruits and vegetables, lawns, trees, and/or ornamental plants. Alternatively, the inhibitors disclosed herein may be formulated as a spray, dust, powder, or other aqueous, atomized or aerosol for killing an invertebrate or controlling an invertebrate population.

Regardless of the method of application, the tyrosine decarboxylase inhibitor is applied in a biocidally-effective amount, which will vary depending on such factors as, for example, the specific target invertebrate to be controlled, the specific environment, location, plant, crop, or agricultural site to be treated, and the method, rate, concentration, stability, and quantity of the tyrosine decarboxylase inhibitor applied. The formulations may also vary with climatic conditions, environmental considerations, and/or frequency of application and/or severity of invertebrate infestation.

The biocidal formulation may be administered to a particular plant or target area in one or more applications, as needed, with a typical field application rate per hectare ranging on the order of about 50, 100, 200, 300, 400, or 500 g/hectare of active ingredient, or alternatively, 600, 700, 800, 900, or 1,000 g/hectare may be utilized. In certain instances, it may be desirable to apply the biocidal formulation to a target area at an application rate of about 1,000, 2,000, 3,000, 4,000, 5,000 g/hectare or even as much as 7,500, 10,000, or 15,000 g/hectare of active ingredient.

Tyrosine decarboxylase inhibitors of the invention can be formulated, for example, as a dust or granular material, a suspension in oil (vegetable or mineral), water, an oil/water emulsion, a pellet, or as a wettable powder, or in combination with any other carrier material suitable for application to a site of infestation. For example, suitable agricultural carriers can be solid or liquid and are well known in the art. Agriculturally acceptable carriers can include adjuvants, inert components, dispersants, surfactants, tackifiers, and binders, that are commonly used in insecticide or nematicide formulations. The formulations may be mixed with one or more solid or liquid adjuvants and prepared by various means, e.g., by homogeneously mixing, blending and/or grinding the biocidal composition with suitable adjuvants using conventional formulation techniques.

The tyrosine decarboxylase inhibitors of the invention may also be used in consecutive or simultaneous application to an environmental site singly or in combination with one or more additional insecticides, pesticides, chemicals, fertilizers, or other compounds.

Other application techniques, including dusting, sprinkling, soil soaking, soil injection, seed coating, seedling coating, foliar spraying, aerating, misting, atomizing, fumigating, aerosolizing, and the like, are also feasible and may be required under certain circumstances, such as to eradicate insects that cause root or stalk infestation, or for application to delicate vegetation or ornamental plants. These application procedures are also well-known to those of skill in the art.

Therapeutic Formulations

The methods and compositions of the invention can be used for the treatment of an invertebrate infection in an animal, e.g., a hookworm infection.

The compositions of the invention may be administered with a pharmaceutically acceptable diluent, carrier, or excipient, in unit dosage form. Administration may be transdermal, parenteral, intravenous, intra-arterial, subcutaneous, intramuscular, intracranial, intraorbital, ophthalmic, intraventricular, intracapsular, intraspinal, intracisternal, intraperitoneal, intracerebroventricular, intrathecal, intranasal, aerosol, by suppositories, or oral administration.

Therapeutic formulations may be in the form of liquid solutions or suspensions; for oral administration, formulations may be in the form of tablets or capsules; and for intranasal formulations, in the form of powders, nasal drops, or aerosols.

Methods well known in the art for making formulations are found, for example, in “Remington: The Science and Practice of Pharmacy” (20th ed., ed. A. R. Gennaro, 2000, Lippincott Williams & Wilkins). Formulations for parenteral administration may, for example, contain excipients, sterile water, or saline, polyalkylene glycols such as polyethylene glycol, oils of vegetable origin, or hydrogenated napthalenes. Biocompatible, biodegradable lactide polymer, lactide/glycolide copolymer, or polyoxyethylene-polyoxypropylene copolymers may be used to control the release of the compounds. Nanoparticulate formulations (e.g., biodegradable nanoparticles, solid lipid nanoparticles, liposomes) may be used to control the biodistribution of the compounds. Other potentially useful parenteral delivery systems include ethylene-vinyl acetate copolymer particles, osmotic pumps, implantable infusion systems, and liposomes. Formulations for inhalation may contain excipients, for example, lactose, or may be aqueous solutions containing, for example, polyoxyethylene-9-lauryl ether, glycolate and deoxycholate, or may be oily solutions for administration in the form of nasal drops, or as a gel. The concentration of the compound in the formulation will vary depending upon a number of factors, including the dosage of the drug to be administered, and the route of administration.

The compound may be optionally administered as a pharmaceutically acceptable salt, such as a non-toxic acid addition salts or metal complexes that are commonly used in the pharmaceutical industry. Examples of acid addition salts include organic acids such as acetic, lactic, pamoic, maleic, citric, malic, ascorbic, succinic, benzoic, palmitic, suberic, salicylic, tartaric, methanesulfonic, toluenesulfonic, or trifluoroacetic acids or the like; polymeric acids such as tannic acid, carboxymethyl cellulose, or the like; and inorganic acid such as hydrochloric acid, hydrobromic acid, sulfuric acid phosphoric acid, or the like. Metal complexes include calcium, zinc, iron, and the like.

Administration of compounds in controlled release formulations is useful where the compound of formula I has (i) a narrow therapeutic index (e.g., the difference between the plasma concentration leading to harmful side effects or toxic reactions and the plasma concentration leading to a therapeutic effect is small; generally, the therapeutic index, TI, is defmed as the ratio of median lethal dose (LD50) to median effective dose (ED50)); (ii) a narrow absorption window in the gastro-intestinal tract; or (iii) a short biological half-life, so that frequent dosing during a day is required in order to sustain the plasma level at a therapeutic level.

Many strategies can be pursued to obtain controlled release in which the rate of release outweighs the rate of metabolism of the therapeutic compound. For example, controlled release can be obtained by the appropriate selection of formulation parameters and ingredients, including, e.g., appropriate controlled release compositions and coatings. Examples include single or multiple unit tablet or capsule compositions, oil solutions, suspensions, emulsions, microcapsules, microspheres, nanoparticles, patches, and liposomes.

Formulations for oral use include tablets containing the active ingredient(s) in a mixture with non-toxic pharmaceutically acceptable excipients. These excipients may be, for example, inert diluents or fillers (e.g., sucrose and sorbitol), lubricating agents, glidants, and antiadhesives (e.g., magnesium stearate, zinc stearate, stearic acid, silicas, hydrogenated vegetable oils, or talc).

Formulations for oral use may also be provided as chewable tablets, or as hard gelatin capsules wherein the active ingredient is mixed with an inert solid diluent, or as soft gelatin capsules wherein the active ingredient is mixed with water or an oil medium.

Pharmaceutical formulations of compounds of formula I can include isomers such as diastereomers and enantiomers, mixtures of isomers, including racemic mixtures, salts, solvates, and polymorphs thereof.

The formulations can be administered to an animal in therapeutically effective amounts. For example, an amount is administered which prevents, reduces, or eliminates the invertebrate infection. Typical dose ranges are from about 0.001 μg/kg to about 2 mg/kg of body weight per day. Desirably, a dose of between 0.001 μg/kg and 1 mg/kg of body weight, or 0.005 μLg/kg and 0.5 mg/kg of body weight, is administered. The exemplary dosage of drug to be administered is likely to depend on such variables as the type and extent of the condition, the overall health status of the particular animal, the formulation of the compound, and its route of administration. Standard clinical trials may be used to optimize the dose and dosing frequency for any particular compound.

Invertebrate Pests

Virtually all field crops, plants, and commercial farming areas are susceptible to attack by one or more invertebrate pests. For example, crops can be susceptible to attack by insects and/or parasitic nematodes. All of the invertebrate pests described herein may be targeted with a tyrosine decarboxylase inhibitor to reduce the proliferation (e.g., slow, delay, inhibit, or arrest the growth, viability, or reproduction of) of the pest.

Tyrosine decarboxylase inhibitor of the invention are expected to demonstrate a very low acute toxicity towards non-targeted organisms, such as plants and animals. The compounds are expected to be useful in targeting a variety of invertebrate species, including, but not limited to, mosquitos, flies, midges, ants, cotton leaf perforator, fleas, roaches, termites, aphids, scales, mites, arachnids, spruce bud worm, and gypsy moths, among others. Particular species against which compounds of the invention may be expected to be effective include, without limitation, american cockroach (Periplaneta Americana), german cockroach (Blattella germanica), yellowfever mosquito (Aedes aeqypti), malaria mosquitos (Anopheles quadrimaculatus, Anopheles gambiae, and Anopheles arabiensis), northern house mosquito (Culex pipens), house fly (Musca domestica), house cricket (Acheta domesticus), corn earworm (Heliothis zea), differential grasshopper (Melanoplus differentialis), and yellow mealworm (Tenebrio molitor).

Insects that can be targeted using the methods and compositions of the invention include, without limitation, insects which attack vegetable, cole crops, and spices, such as alfalfa looper, armyworm, beet armyworm, artichoke plume moth, cabbage budworm, cabbage looper, cabbage webworm, corn earworm, celery leafeater, cross-striped cabbageworm, european corn borer, diamondback moth, green cloverworm, imported cabbageworm, melonworm, omnivorous leafroller, pickleworm, rindworm complex, saltmarsh caterpillar, soybean looper, tobacco budworm, tomato fruitworm, tomato hornworm, tomato pinworm, velvetbean caterpillar, and yellowstriped armyworm; insects which attack pasture and hay crops, such as armyworm, beef armyworm, alfalfa caterpillar, European skipper, a variety of loopers and webworms, as well as yellowstriped armyworms; insects which attack fruit and vine crops, such as achema sphinx moth, amorbia, armyworm, citrus cutworm, banana skipper, blackheaded fireworm, blueberry leafroller, cankerworm, cherry fruitworm, citrus cutworm, cranberry girdler, eastern tent caterpillar, fall webworm, fall webworm, filbert leafroller, filbert webworm, fruit tree leafroller, grape berry moth, grape leaffolder, grapeleaf skeletonizer, green fruitworm, gummosos-batrachedra commosae, gypsy moth, hickory shuckworm, hornworms, loopers, navel orangeworm, obliquebanded leafroller, omnivorous leafroller. omnivorous looper, orange tortrix, orangedog, oriental fruit moth, pandemis leafroller, peach twig borer, pecan nut casebearer, redbanded leafroller, redhumped caterpillar, rougliskinned cutworm, saltmarsh caterpillar, spanworm, tent caterpillar, thecla-thecla basillides, tobacco budworm, tortrix moth, tufted apple budmoth, variegated leafroller, walnut caterpillar, western tent caterpillar, and yellowstriped armyworm; insects which attack field crops, such armyworm, asian and other corn borers, banded sunflower moth, beet armyworm, bollworm, cabbage looper, corn rootworm (including southern and western varieties), cotton leaf perforator, diamondback moth, european corn borer, green cloverworm, headmoth, headworm, imported cabbageworm, loopers (including Anacamptodes spp.), obliquebanded leafroller, omnivorous leaftier, podworm, podworm, saltmarsh caterpillar, southwestern corn borer, soybean looper, spotted cutworm, sunflower moth, tobacco budworm, tobacco hornworm, and velvetbean caterpillar; insects which attack bedding plants, flowers, or ornamentals, such as armyworm, azalea moth, beet armyworm, diamondback moth, ello moth (hornworm), Florida fern caterpillar, lo moth, loopers, oleander moth, omnivorous leafroller, omnivorous looper, and tobacco budworm; insects which attack trees and shrubs, such as bagworm, blackheaded budworm, browntail moth, California oakworm, douglas fir tussock moth, elm spanworm, fall webworm, fuittree leafroller, greenstriped mapleworm, gypsy moth, jack pine budworm, mimosa webworm, pine butterfly, redhumped caterpillar, saddleback caterpillar, saddle prominent caterpillar, spring and fall cankerworm, spruce budworm, tent caterpillar, tortrix, and western tussock moth; and insects which attack grasses, such as armyworm, sod webworm, and tropical sod webworm.

Nematode that can be targeted using the methods and compositions of the invention include, without limitation, nematodes of the Family Longidoridae (e.g., Xiphinema spp. and Longidorus spp.) and Trichodoridae, (e.g., Trichodorus spp. and Paratrichodorus spp.), migratory ectoparasites belonging to the Families Anguinidae (e.g., Ditylenchus spp.), Dolichodoridae (Dolichodorus spp.) and Belenolaimidae (e.g., Belenolaimus spp. and Trophanus spp.).; obligate parasites belonging to the —Families Pratylenchidae (e.g., Pratylenchus spp., Radopholus spp., and Nacobbus spp.), Hoplolaimidae (e.g., Helicotylenchus spp., Scutellonema spp., and Rotylenchulus spp.), Heteroderidae (e.g., Heterodera spp., Globodera spp., Meloidogyne spp., and Meloinema spp.), Criconematidae (e.g., Croconema spp., Criconemella spp., Hemicycliophora spp.), and Tylenchulidae (e.g., Tylenchulus spp., Paratylenchulus spp., and Tylenchocriconema spp.); and parasites belonging to the Families Aphelenchoididae (e.g., Aphelenchoides spp., Bursaphelenchus spp., and Rhadinaphelenchus spp.) and Fergusobiidae (e.g., Fergusobia spp.).

The methods and compositions of the invention can be used to treat an infection in an animal (e.g., a human) by any parasitic nematode, including, without limitation, heartworm, hookworm, roundworm, whipworm, pinworm, and specifically, Strongyloides stercoralis, Onchocerca volvulus, Trichostrongylus colubriformis, Haemonchus contortus, Dictyocaulus viviparus, Ascaris suum, W. bancrofti, Necator americanus, Ancylostoma duodenale, Ascaris lumbricoides, and Trichinella spp.

The following experimental results are put forth so as to provide those of ordinary skill in the art with a complete disclosure and description of how the methods and compounds claimed herein are performed, made, and evaluated, and are intended to be purely exemplary of the invention and are not intended to limit the scope of what the inventors regard as their invention.

### Experimental Results

H13N06.6 Encodes Tyramine β-hydroxylase

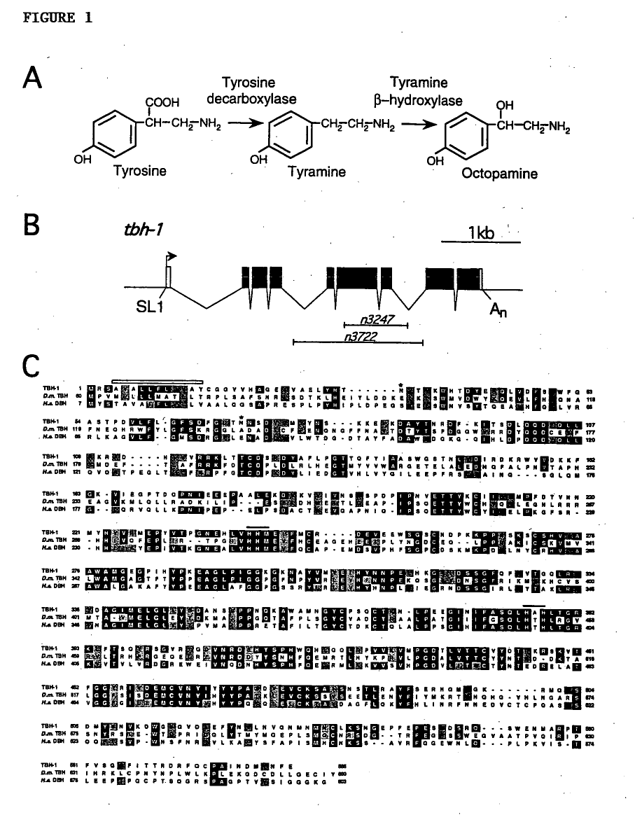

The C. elegans genome sequence contains a single gene, H13N06.6, that encodes a protein with significant similarity to the Drosophila tyramine β-hydroxylase (TBH) (Monastirioti et al., J. Neurosci. 16:3900-3911 (1996)) and mammalian dopamine β-hydroxylase (DBH) (Lamouroux et al., EMBO J. 6:3931-3937 (1987)). We named this gene tbh-1 (tyramine β-hydroxylase) and obtained a 1.9 kb full-length complementary DNA (cDNA) clone for tbh-1 (FIG. 1B). The open reading frame of the tbh-1 cDNA encodes a 561 amino acid protein that shares 32% identity with both Drosophila TBH and human DBH (FIG. 1C). We isolated two tbh-1 deletion alleles by screening libraries of mutagenized animals using PCR (Jansen et al., Nat. Genet. 17:119-121 (1997)). Both deletions removed parts of the tbh-1 locus that encode domains conserved between the Drosophila and human β-hydroxylases.

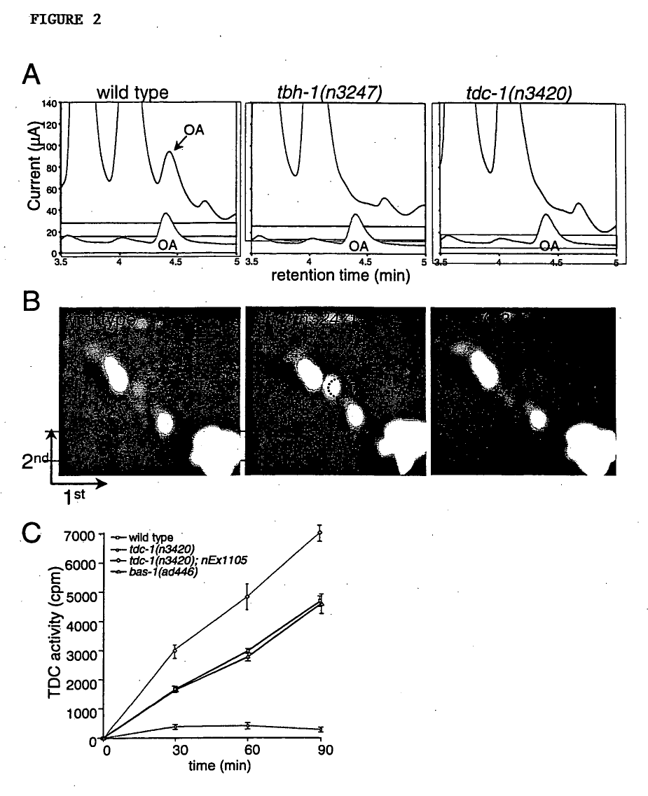

To determine whether TBH-1 is required for octopamine biosynthesis we measured the octopamine content of tbh-1 mutants using HPLC coupled to electrochemical detection. HPLC analysis of extracts of wild-type animals showed a peak with the same retention time as octopamine (FIG. 2A). Spiking the sample with octopamine increased the peak area, indicating that this peak represents octopamine. The octopamine content was 5+/−2 pmol per μg of wet weight, similar to estimates obtained from radioenzymatic assays (Horvitz et al., Science 216:1012-1014 (1982)). In extracts from tbh-1 mutant nematodes the octopamine peak was absent (FIG. 2B).

We also examined tyramine levels using thin-layer chromatography (TLC) of dansylated C. elegans extracts (FIG. 2B). TLC of wild-type nematode extracts showed a spot that comigrated with the dansylated derivative of tyramine. Wild-type animals contained approximately 0.3+/−0.1 pmol tyramine per μg of wet weight. Tyramine levels were approximately 20-fold increased in tbh-1 mutant animals, presumably because tyramine could no longer be converted to octopamine in the absence of tyramine β-hyroxylase activity. A similar increase in tyramine was found in Drosophila tyramine β-hydroxylase mutants (Monastirioti et al., J. Neurosci 16:3900-3911 (1996)). These data indicate that TBH-1 is a tyramine β-hydroxylase required for octopamine biosynthesis.

K01C8.3 Encodes Tyrosine Decarboxylase

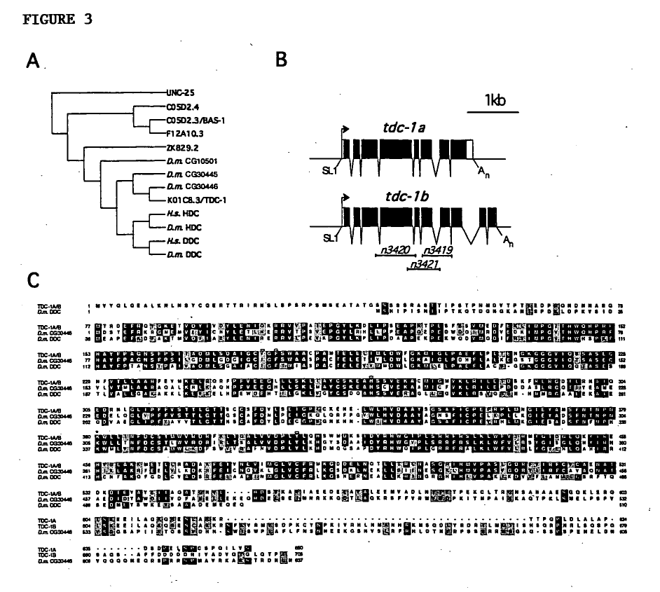

We sought to identify a C. elegans L-aromatic amino acid decarboxylase (AADC) gene required for the decarboxylation of tyrosine, the first step in octopamine biosynthesis. AADCs are homodimeric pyridoxal 5′-phosphate (PLP) enzymes that can decarboxylate many naturally occurring L-aromatic amino acids. We identified five putative C. elegans AADC genes C05D2.3, C05D2.4, F12A10.3, K01C8.3 and ZK829 (FIG. 3A) on the basis of their similarity to mammalian and insect DOPA decarboxylases (DDCs). To determine whether any of these genes are required for tyramine biosynthesis, we obtained deletion alleles of the corresponding putative decarboxylases genes and assayed tyramine content using TLC. C05D2.3, C05D2.4/bas-1, F12A10.3 and ZK829.2 deletion mutants had normal tyramine levels, whereas KOlC8.3 deletion mutants lacked tyramine (FIG. 2B). K01C8.3 deletion mutants had normal dopamine and serotonin levels, as judged by formaldehyde-induced fluorescence (Sulston et al., J. Comp. Neurol 163:215-226 (1975)) and serotonin immunohistochemistry (Horvitz et al., Science 216:1012-1014 (1982)) (data not shown), but lacked octopamine, as shown by HPLC analysis (FIG. 2A). These observations indicated that K01C8.3 encodes a tyrosine decarboxylase required for the first step in octopamine biosynthesis in C. elegans. We named this gene tdc-1 (tyrosine decarboxylase).

tdc-1 encodes two different splice variants, tdc-1a and tdc-1b, which differ at their 3′ ends (FIG. 3B). The tdc-1a messenger encodes a 651 amino acid protein; the tdc-1b transcript uses a cryptic splice donor site in exon 8 and encodes a 706 amino acid protein. The TDC-1A/B predicted proteins contain several regions conserved in PLP-dependent decarboxylases, including a lysine residue important for PLP binding (FIG. 3C). All three tdc-1 deletion alleles (FIG. 3B) removed parts of the tdc-1 gene that encode domains highly conserved in PLP-dependent decarboxylases. A BLAST search against TDC-1 identified the Drosphila protein CG30446 and the predicted orthologous proteins XP_{—}394424, of honey bee Apis Mellifera, and XP_{—}308519, of mosquito Anopheles gambiae, as the closest homologs of TDC-1. TDC-1 shares 40% identity with Drosophila Ddc compared to 50% identity to the Drosophila CG30446 protein and to the mosquito CP3581 proteins (FIG. 3C), suggesting that CG30446, XP_{—}394424, and XP_{—}308519 are insect tyrosine decarboxylases.

We examined tyrosine decarboxylase activity in worm extracts by measuring the conversion of [³H]tyrosine to [³ H]tyramine. Tyrosine decarboxylase activity was present in wild-type extracts, but was almost undetectable in extracts from tdc-1 mutants (FIG. 2C). Tyrosine decarboxylase activity was rescued in transgenic tbc-1 mutants carrying a genomic tbc-1 fragment. Since Drosophila Ddc can decarboxylate tyrosine in vitro, albeit with much lower affinity (Livingstone et al., Nature 303:67-70 (1983)), we also assayed tyrosine decarboxylase activity in C05D2.4/bas-1 mutant extracts, which lack DOPA decarboxylase. We found that TDC activity in bas-1 extracts was similar to that in the wild type. Our data suggest that tbc-1 encodes the major tyrosine decarboxylase in C. elegans.

TBH-1 is Expressed in a Subset of Cells that Express TDC-1

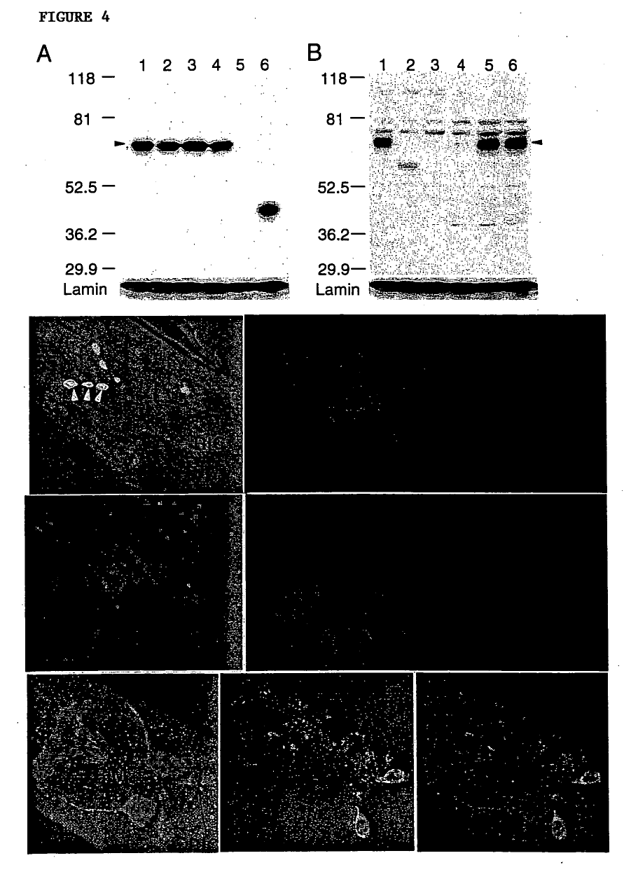

To analyze the expression patterns of tbh-1 and tdc-1, we generated polyclonal rabbit antibodies against the TBH-1 and TDC-1 proteins. TBH-1 antibodies recognized a single band of approximately 70 kDa in wild-type protein extracts, in accordance with the TBH-1 predicted size of 67 kDa. The 70 kDa band was absent in extracts from tbh-1 mutants (FIG. 4A). TDC-1 antibodies recognized a 75 kDa band in agreement with the predicted sizes of 73.2 kDa and 79.7 kDa of TDC-1A and TDC-1B, respectively; this band was absent in the tdc-1 mutants (FIG. 4B).

C. elegans whole-mount staining with TBH-1 antibodies labeled a single pair of head interneurons in the lateral ganglion: we identified these neurons as the RICs (FIG. 4C). Bright staining was observed in RIC synaptic regions, as indicated by a punctate immunofluorescence pattern in the nerve ring, whereas weaker staining was observed in the RIC neuronal processes and cell bodies. By contrast, TBH-1 staining was predominantly localized to the RIC cell bodies of mutants defective in the unc-104 gene (data not shown), which encodes a neuron-specific kinesin required for the anterograde transport of synaptic vesicles (Hall et al., Cell 65:837-847 (1991)). Axon outgrowth is normal in unc-104 mutants, but synaptic vesicles remain clustered in cell bodies. These observations suggest that TBH-1 is associated with synaptic vesicles. We also observed punctate TBH-1 staining in the gonadal sheath cells of adult hermaphrodites (FIG. 4C). The gonadal sheath is formed by five pairs of cells that envelop most of the gonad arm (Strome, S., J. Cell Biol. 103:2241-2252 (1986)). TBH-1 staining was most prominent in the proximal three pairs of sheath cells, which form a contractile myoepithelium that expels the oocytes from the gonad during ovulation. A punctate staining of the gonadal sheath cells is also observed with actin and myosin antibodies. Perhaps TBH-1 is associated with actomyosin filaments in the gonadal sheath cells.

TDC-1 was coexpressed with TBH-1 in the RICs and gonadal sheath cells (FIG. 4G,F), suggesting that these cells are octopaminergic. TDC-1 staining was observed in the cell bodies and axonal processes of the neurons and throughout the gonadal sheath cells, indicating that TDC-1 is cytoplasmic. The expression of TBH-1 and TDC-1 in the gonadal sheath cells (FIG. 4F-I) may account for the dramatic increase in octopamine content of adults compared to larvae (Horvitz et al., Science 216:1012-1014 (1982)). The subcellular localizations of TDC-1 and TBH-1 suggest that tyramine is transported into synaptic vesicles, where it is converted to octopamine.

Surprisingly, we found that TDC-1 was highly expressed in a few cells that did not express TBH-1. We observed bright staining of a pair of neurons in the lateral ganglion. We identified these cells as the RIM motor neurons (FIG. 4G). Four uterine cells, which we identified as the UV1 cells (FIG. 4E), also expressed TDC-1. Expression in the uterine cells was not observed until the late L4 stage, the time at which the UV1 cells are generated (Newman et al., Development 122:3617-3626 (1996)). The expression of TDC-1 but not TBH-1 in the RIMs and UV1 cells suggests that these cells use tyramine in signalling, although we cannot exclude the possibility that tyramine serves as an intermediate for the biosynthesis of another molecule in these cells. The octopaminergic RIC neurons expressed TDC-1 at much lower levels than do the tyraminergic RIM neurons (FIG. 4G). Perhaps this difference results in a complete conversion of tyramine into octopamine in the synaptic vesicles of the RIC neurons.

tbc-1 Mutants are Hyperactive in Egg Laying

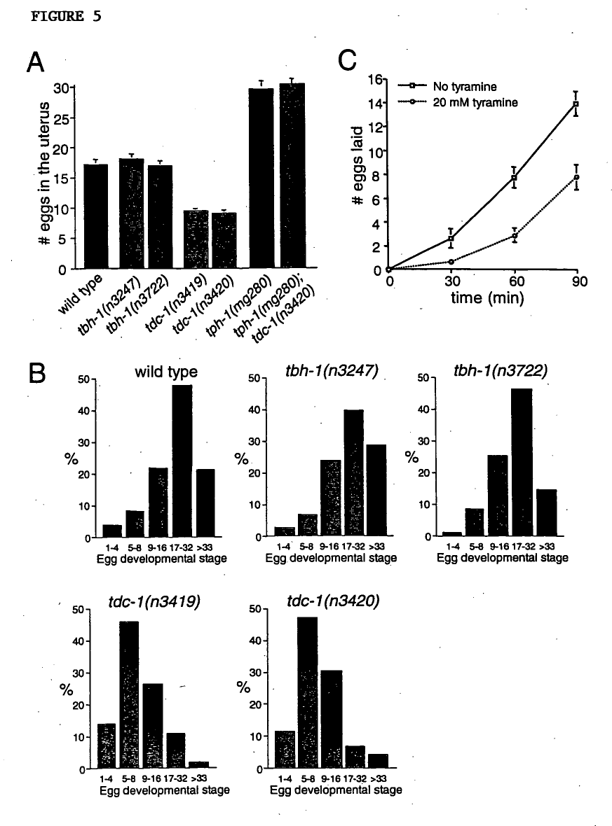

tbh-1 and tbc-1 deletion mutants were viable and healthy and had normal brood sizes (data not shown). tbh-1 and tdc-1 mutants both had a slightly reduced locomotion rate and defects in the inhibition of pharyngeal pumping and egg laying in the absence of food. Since tdc-1 and tbh-1 mutants both lack octopamine, the behavioral defects tbh-1 and tdc-1 mutants have in common suggests a role for octopamine in the modulation of locomotion, pharyngeal pumping and egg laying. tbc-1 mutants also had defects not shared with tbh-1 mutants: tdc-1 mutants were hyperactive in egg laying in the presence of food, failed to suppress head oscillations in response to touch and had defects in the coordination of forward and backward locomotion (see below). tbc-1 mutants had a reduced number of eggs in the uterus compared to wild-type animals and tbh-1 mutants (FIG. 5A). The egg-laying rate of tbc-1 mutants was comparable to wild-type and tbh-1 mutant animals (wild type 9.6+/−0.5, tbh-1(n3247) 9.5+/−0.5 tbh-1(n3722) 10.0+/−0.5, tdc-1(n3419) 9.2+/−0.5 and tdc-1(n3420) 10.0+/−0.5 eggs/hour). However, tdc-1 mutants laid their eggs at an earlier developmental stage than did wild-type animals and tbh-1 mutants. Specifically, the wild type and tbh-1 mutants laid most eggs at the nine-cell to comma stage. tdc-1 mutants laid most of their eggs at the 1-8 cell stage (FIG. 5B), indicating that the time between fertilization and egg laying was reduced in tdc-1 mutants.

tbc-1 mutants, unlike tbh-1 mutants, are hyperactive in egg laying behavior in the presence of food suggesting that tyramine plays a role independent of octopamine in the inhibition of egg laying in vivo. We therefore tested the effect of exogenous tyramine on egg laying behavior. Egg laying was inhibited on Petri plates containing 20 mM tyramine (FIG. 5C). The inhibitory effect of exogenous tyramine on egg laying was similar to the inhibitory effect of exogenous octopamine (Horvitz et al., Science 216:1012-1014 (1982)). Egg laying is regulated in part by the serotonergic HSN neurons, which induce muscle contraction of the vulva muscles (Trent et al., Genetics 104:619-647 (1983)). Serotonin-deficient tph-1 mutants are egg-laying defective (Eg1-D): they retain more eggs in the uterus and eggs are laid at a later stage (Sze et al., Nature 403:560-564 (2000). tph-1; tbc-1 double mutants were Egl-D, similar to the tph-1 single mutant (FIG. 5A), indicating that tbc-1 acts upstream of and/or parallel to tph-1 in egg laying.

Anterior Touch Sensory Neurons Mediate the Suppression of Head Oscillations

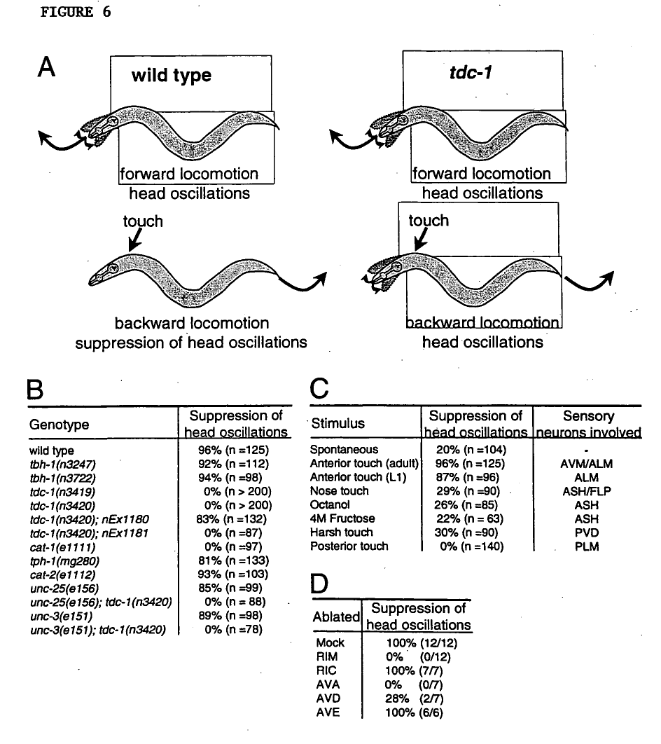

We found that tbc-1 mutants failed to suppress head oscillations in response to anterior touch (see below). C. elegans locomotion is accompanied by oscillatory head movements during which the tip of the nose moves rapidly from side to side (FIG. 6A) (Croll et al., J. Zool., Lond. 184:507-517 (1978)). The tip of the nose contains the endings of several sensory neurons, and head oscillations may allow the animal to explore its immediate environment and may contribute to chemotactic and thermotactic behaviors. Locomotion and head movements are controlled by different muscle groups: locomotion is controlled by the body-wall muscles and is restricted to dorsal/ventral flexures, while head movements are controlled by eight radially symmetric muscle groups that allow C. elegans to move its head through 360° (White et al., Philos. Trans. R. Soc. Lond. B. Biol. Sci 314:1-340 (1986)). Head movements are regulated independently from locomotion, since animals that were feeding but not moving still displayed head oscillations.

Light touch of an eyelash to the anterior half of the body induced a backing response. We found that during this backing response, head oscillations were suppressed in wild-type animals (FIG. 6A); head oscillations resumed as soon as forward locomotion was reinitiated. The analysis of the C. elegans touch response lead to the identification of the responsible mechanosensory neurons and the characterization of the neural circuit that controls forward and backward locomotion in C. elegans (Chalfie et al., J. Neurosci. 5:956-964 (1985). Light anterior touch, sensed by the ALM/AVM mechanosensory neurons, induces a backing response, whereas light posterior touch, sensed by the PLM mechanosensory neurons, accelerates forward locomotion. We found that adult mec mutants did not suppress head oscillations in response to anterior touch, indicating that the touch cells mediate the suppression of head oscillations. In young larvae (L1) the anterior touch response depends solely on the ALM touch sensory neurons, because the AVMs develop in L4 larval stage (Chalfie et al., J. Neurosci. 5:956-964 (1985). Young larvae also suppressed head oscillations in response to anterior touch, indicating that the ALM touch sensory neurons are sufficient to mediate the touch response to the suppression of head oscillations. Gentle posterior touch, sensed by the PLM neurons, never induced the suppression of head oscillations. Forward locomotion was always associated with head oscillations.

We noticed that head oscillations were usually not suppressed during spontaneous reversals. We asked whether other stimuli that, like gentle touch, induced backward locomotion, lead to the suppression of head oscillations. Nose touch, volatile repellents and high osmolarity induce an avoidance response and are mainly sensed by the ASH sensory neurons (Kaplan et al., Proc. Natl. Acad. Sci. U.S.A. 90:2227-2231 (1993)). Backward locomotion induced by these stimuli usually did not suppress head oscillations (FIG. 6B). The C. elegans response to harsh touch with a platinum wire is mediated by the PVD sensory neurons and results either in the acceleration of forward locomotion or a backing response (Way et al., Genes Dev. 3:1823-1833 (1989)). Head oscillations were not suppressed in most animals in which backward locomotion was induced by harsh touch. These observations indicated that backward locomotion is not sufficient for this suppression. To address the question of whether backward locomotion is necessary for the suppression of head oscillations in response to anterior touch, we examined the response of unc-3 mutants to anterior touch. unc-3 encodes an O/E transcription factor required for the axonal outgrowth of the motor neurons of the ventral cord (Prasad et al., Development 125:1561-1568 (1998). As a consequence unc-3 mutants are largely immobilized. unc-3 mutants still displayed normal head oscillations because the ventral cord motor neurons do not innervate the head muscles. Anterior touch of unc-3 mutants did not induce backward locomotion but did suppress head oscillations (FIG. 6C), indicating that backward locomotion is not required for the suppression of head oscillations.

tbc-1 is Required to Suppress Head Oscillations in Response to Anterior Touch

Head oscillations were normal in tdc-1 mutants during forward locomotion and tbc-1 mutants normally induced backing in response to light touch. tbc-1 mutants, however, failed to suppress head oscillations during backward locomotion (FIG. 6A,B). The defect in suppression of head oscillations was rescued by a tbc-1 genomic clone (tdc-1(n3420); nEx1180), but not by a frame-shifted mutant of this clone (tdc-1 (n3420); nEx1181). Octopamine-deficient tbh-1 mutants, dopamine-deficient cat-2 mutants, and serotonin-deficient tph-1 mutants did suppress head oscillations (FIG. 6C). However, cat-1 mutants failed to suppress head oscillations in response to anterior touch. CAT-1 can transport biogenic amines, including tyramine, when expressed in mammalian cells (Duerr et al., J. Neurosci. 19:72-84 (1999)).

C. elegans head muscles are innervated by five classes of motor neurons (White et al., Philos. Trans. R. Soc. Lond. B. Biol. Sci. 314:1-340 (1986)): the IL1 sensory-motor neurons, the cholinergic RMD and SMD motor neurons, the GABAergic RME motor neurons, and the tyraminergic RIM motor neurons. Acetylcholine acts as an excitatory neurotransmitter at the C. elegans neuromuscularjunction. cha-1(p1152) mutants have a strongly reduced choline acetyl transferase activity and display uncoordinated locomotion (Rand et al., Genetics 106:227-248 (1984)) and uncoordinated head movement with few head oscillations. Ablation of RMD neurons results in the in the loss of head oscillations. GABA is the main inhibitory neuromuscular transmitter in C. elegans, and GABA-deficient unc-25 mutants and RME-ablated animals display loopy head oscillations. Ablation of the IL1 and OLQ sensory neurons also results loopy head oscillations suggesting an inhibitory role for the IL1 and OLQ neurons in head muscle contraction. To determine whether the suppression of head oscillations is GABA-dependent, we examined the anterior touch response in unc-25 mutants. unc-25 mutant animals had a reduced backing response but nonetheless suppressed head oscillations in response to anterior touch (FIG. 6C), indicating that GABA was not required for the suppression of head oscillations. unc-25; tbc-1 double mutants failed to suppress head oscillations in response to anterior touch and in addition showed a striking hypercontraction of head muscles compared to unc-25 mutants. These observations suggested that tyramine is required for the inhibition of head muscle contractions in response to anterior touch.

tbc-1 Mutants Have Defects in Reversal Behavior

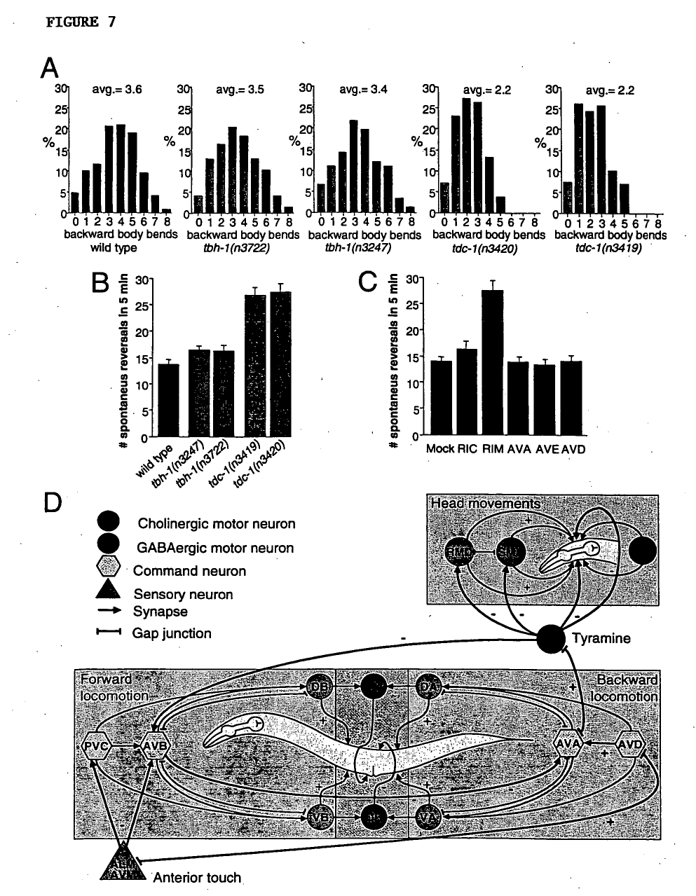

We noticed that in response to anterior touch tbc-1 mutants backed less than wild-type animals and often displayed slightly jerky backward locomotion. Wild-type animals and tbh-1 mutants reversed on average 3.4 to 3.6 body bends, respectively in response to anterior touch (FIG. 7A). tdc-1 mutants initiated backward locomotion normally in response to anterior touch but backed on average only 2.2 body bends.

C. elegans reversal frequency can be modulated by chemosensory cues (Pierce-Shimomura et al., J. Neurosci. 19:9557-9569 (1999), humidity (Zhao et al., J. Neurosci. 23:5319-5328 (2003)), temperature, and food (Tsalik et al., J. Neurobiol. 56:178-197 (2003)), which allows the animal to explore its environment in search of favorable conditions. On plates without food, wild-type animals made approximately 15 spontaneous reversals in 5 minutes (FIG. 7B). Similarly, tbh-1 mutants made about 16 reversals. By contrast, tdc-1 (n3420) and tdc-1(n3419) mutants made 30 reversals in five minutes. However, as with the reduced backing response induced by touch, tbc-1 mutants backed less far during spontaneous reversals than did wild-type or tbh-1 mutant animals (data not shown). These data suggested that tdc-1 mutants fail to sustain backward locomotion once it is initiated and suggested a role for tyramine in reversal behavior.

The RIM Motor Neurons Modulate Reversal Frequency and are Required for the Suppression of Head Oscillations

The defects of tdc-1 mutants in egg laying, suppression of head oscillations and reversal behavior were not shared by the tbh-1 mutants suggesting a distinct role for tyramine in these behaviors. However, since tdc-1 mutants also lack octopamine we could not exclude a role for octopamine in these behaviors. We therefore analyzed the behavior of animals in which either the tyraminergic, or octopaminergic, neurons were killed by laser ablation. We found that animals in which the tyraminergic RIMs were ablated had an impaired backing response to anterior touch and failed to suppress head oscillations (FIG. 6C). The RIM-ablated animals also showed a dramatic increase in the number of spontaneous reversals, similar to tdc-1 mutants (FIG. 7C, consistent with findings by Zheng et al. (1999), who found that RIM ablations lead to a decrease in forward run duration. The phenotype of the RIM-ablated animals mimicked the phenotype of tdc-1 mutants, showing that the tyraminergic RIM motor neurons are required both for the suppression of head oscillations and reversal behavior. In contrast, mock-ablated and RIC-ablated animals showed a normal backing response and had no defects in the suppression of head oscillations in response to anterior touch (FIG. 6C). In addition, the reversal frequency of RIC-ablated animals was similar to that of mock-ablated animals (FIG. 7C).

The AVA and AVD Backward-locomotion Command Neurons are Required for the Suppression of Head Oscillations in Response to Anterior Touch

The ALM/AVM and PLM mechanosensory neurons provide inputs to four pairs of locomotion command interneurons: the PVCs and AVBs, which are mainly required for forward locomotion, and the AVAs and AVDs, which generally drive backward locomotion (Chalfie et al., J. Neurosci 5, 956-964 (1985)). Laser ablation studies indicate that the locomotion command neurons cannot be strictly categorized in forward and backward (Hart et al., Nature 378:82-85 (1995); and Zheng et al., Neuron 24:347-361 (1999)), but rather form a bistable circuit that controls the direction of the animal's movement. Since the tyraminergic RIM motor neurons make gap junctions with the AVA and AVE backward command neurons, we tested the role of these neurons in the suppression of head oscillations in response to anterior touch (FIG. 6D and 7C). AVA-ablated animals back in response to anterior touch but backing is uncoordinated (Chalfie et al., J. Neurosci. 5:956-964 (1985)). We found that head oscillations were not suppressed in response to anterior touch in AVA-ablated animals, suggesting that the gap junctions between the RIM and AVA neurons are important in linking the touch response to the suppression of head oscillations. In contrast, AVE-ablated animals showed a normal backing response and normally suppressed head oscillation in response to anterior touch.

Cell-ablation studies using laser microsurgery support a model in which the ALM and AVM touch neurons activate the AVD backward command interneuron via gap junctions and inhibit forward locomotion command neurons through synaptic connections with the PVC and AVB forward command neurons. To test the role of the AVD neurons in coupling the touch response to the suppression of head oscillations we ablated the AVD neurons. Five out seven AVD-ablated animals failed to suppress head oscillations, in response to anterior touch, consistent with the hypothesis that the AVD neurons transduce the touch response to the RIM neurons. We found that ablation of the AVD, AVA or AVE neurons did not affect the spontaneous reversal frequency (FIG. 7C). These observations suggested that ALM/AVM sensory neurons stimulate the release of tyramine from the RIM neurons through the activation of the AVA and AVD backward locomotion command neurons.

Tyraminergic Cells are Distinct from Octopaminergic Cells

We identified two genes required for octopamine biosynthesis in C. elegans. tbc-1 a tyrosine decarboxylase gene required for the conversion of tyrosine into tyramine and tbh-1, a tyramine β-hydroxylase gene, is required for the conversion of tyramine to octopamine. Our characterization of tbc-1 provides the first description of an animal tyrosine decarboxylase gene. TBH-1 and TDC-1 are coexpressed in the RIC interneurons and gonadal sheath cells, indicating that these cells are octopaminergic. In contrast, TDC-1, but not TBH-1, is expressed in the RIM motor neurons and in the UV1 cells, indicating that these cells are tyraminergic. Thus, C elegans appears to have tyraminergic cells that are distinct from octopaminergic cells. Vertebrates use a similar strategy to generate dopaminergic and noradrenergic neurons: noradrenergic cells express DOPA decarboxylase and dopamine β-hydroxylase, and the dopaminergic neurons express DOPA decarboxylase but not dopamine β-hydroxylase (Muller et al., Neuroscience 11:733-740 (1984); Mercer et al., Neuron 7:703-716 (1991); and Chatelin et al., Brain Res. Mol. Brain Res. 97:149-160 (2001)). Until the mid-1950s dopamine was considered to be simply an intermediate in the biosynthesis of norepinephrine and epinephrine.

Tyramine was also initially thought to be simply a precursor octopamine. However, the identification of G-protein coupled receptors in Drosophila (Saudou et al., EMBO J. 9:3611-3617 (1990)), the locust (Vanden Broeck et al., J. Neurochem. 64:2387-2395 (1995)), the honey bee (Blenau et al., J. Neurochem. 74:900-908 (2000)), the silk moth (Ohta et al., Insect Mol. Biol. 12:217-223 (2003)). and C. elegans (Rex et al., J. Neurochem. 82:1352-1359 (2002)) that respond to tyramine suggested that tyramine may itself act as a neurotransmitter.

Tyramine Inhibits Egg Laying, Modulates Reversal Behavior and is Required for the Suppression of Head Oscillations in Response to Anterior Touch.

tbc-1 mutants have behavioral defects that are not shared by tbh-1 mutants, suggesting a specific role for tyramine in these behaviors. tdc-1 mutants are hyperactive in egg laying and exogenous tyramine inhibits egg laying, indicating that tyramine inhibits egg laying in vivo. The tyraminergic UV1 cells form adherens junctions with the utse and the vulF vulval cells and connect the uterus with the vulva. The close proximity of the UV1 cells to the vulval muscles suggests that they may be important for the tyramine-mediated inhibition of egg laying. The UV1 cells contain neurosecretory vesicles and express neuropeptides (Schinkmann et al., J. Comp. Neurol. 316, 251-260 (1992)) and several neurosecretory proteins, including SNT-1 synaptotagmin, (Nonet et al., Mol. Biol. Cell 10:2343-2360 (1999)), UNC-64 syntaxin (Saifee et al., Mol. Biol. Cell 9:1235-1252 (1998)), UNC-11 AP180 (Nonet et al., Mol. Biol. Cell 10:2343-2360 (1999)) and IDA-1 phogrin-IA-2 (Zahn et al., J. Comp. Neurol. 429:127-143 (2001), suggesting a paracrine role for the UV1 cells.

Light anterior touch, sensed by the mechanosensory ALM and AVM neurons, induces a backing response. We showed that during this backing response head oscillations are suppressed. tdc-1 mutants and RIM-ablated animals failed to suppress head oscillation in response to anterior touch. Our data suggested that the tyraminergic RIM motomeurons, which innervate the head muscles and make synaptic connections with the cholinergic RMD and SMD head motomeurons, are required for the inhibition of head muscle contractions.

The touch response is linked to the suppression of head oscillations. The RIM motomeurons also make synaptic contacts with the AVB forward locomotion command neurons and make gap junctions with the AVA backward locomotion command neurons (White et al., Philos. Trans. R. Soc. Lond. B. Biol. Sci. 314: 1-340 (1986)). Our results are consistent with the model of Chalfie et al., J. Neurosci. 5:956-964 (1985) in which tactile stimulation of the ALM/AVM anterior touch sensory neurons leads to the activation of the AVD command neurons, which in turn activate the AVA command neurons (FIG. 7D). We propose that the RIM motor neurons are activated through gap junctions by the AVA neurons, leading to the release of tyramine, which inhibits the cholinergic RMD and SMD head motor neurons, head muscle contraction and head oscillations. Head oscillations are suppressed less often when backing is induced by harsh touch, sensed by the PVD neurons, and nose touch and osmotic stimuli, sensed by the ASH neurons. The ASH neurons make synaptic contacts with the AVA and AVD backward command neurons, whereas the PVD only make synaptic contacts with the AVA neurons. In general, animals back further in response to anterior touch than to nose touch, osmotic avoidance or harsh touch (data not shown). This may suggest that upon stimulation the ALM/AVM mechanosensory neurons provide a greater stimulus to the AVA neurons than the ASH and PVD neurons, which might be required to trigger tyramine release from the RIM neurons. Alternatively, other neural connections may play a role to the suppression of head oscillations in response to anterior touch. For instance, the ALM mechanosensory neurons also have synaptic outputs to the RMD head motor neurons, which likely inhibit the RMD motorneurons.

tbc-1 mutants and RIM-ablated animals also have defects in reversal behavior. Tyramine release from the RIMs may link the activation of the AVA neurons with the inhibition of the AVB neurons. Failure to properly inhibit the AVB forward command neurons during backing may lead to premature reinitiation of forward locomotion, as observed in tbc-1 mutants and RIM ablated animals. The connectivity of the RIM motor neurons with the locomotion command neurons may contribute to the coordination of the locomotion command neurons. RIM ablations or tyramine deficiency may change the steady state of the bistable circuit formed by the locomotion command neurons and lead to an increased reversal frequency.

C. elegans suppresses head oscillations in response to anterior touch but not in response to nose touch or posterior touch. The touch response of C. elegans could allow the animal to escape from nematophagous fungi, which use trapping devices along their hyphae to catch live nematodes. Fungi such as Arthrobotrys dactyloides and Dactylaria brochopaga use constricting rings to entrap nematodes. When a nematode moves into the ring, the contact triggers the swelling of the ring cells and can lead to the capture of the nematode. There is a lag time between the initial contact and the closure of the ring, allowing some nematodes to withdraw from the ring before being caught. The suppression of head oscillations in response to anterior touch may allow the nematode to smoothly retreat without the surrounding fungal ring and thereby and increase the chances of the nematode to escape from this death trap.

The experiments described above were carried out as follows.

Strains and Germline Transformation

All strains were cultured at 20° C. on NGM agar plates with the E. coli strain OP50 as a food source (Brenner, S., Genetics 77:71-94 (1974)). tbh-1 and tdc-1 deletion alleles were obtained by screening a chemical deletion library (Jansen et al., Nat. Genet. 17:119-121 (1997)). All deletions strains were outcrossed at least six times. Full-length tbh-1 cDNA sequence was obtained from expressed sequence tag (EST) clone yk722g9. Partial tdc-1 cDNA sequences were obtained from EST clones yk374c1 (tdc-1a) and yk303a5 (tdc-1b). The 5′ end sequence of the tbc-1 cDNA was determined by 5′ RACE. A tbh-1::gfp transcriptional fusion construct was made by cloning a 4.5 kb tbh-1 promoter fragment corresponding to nucleotide (nt)−4537 to +17 relative to the translational start site into the vector pPD95.67. A tdc-1::gfp reporter construct was obtained by cloning a PstI fragment corresponding to nt−4423 to +443 into the vector pPD95.69. GFP constructs were injected at 80 ng/μL into lin-15(n765ts) animals along with the lin-15 rescuing plasmid pL15EK at 50 ng/μL. A tdc-1 genomic NsiI fragment, corresponding to nt−917 to +2522, and a fragment corresponding to nt−4423 to +3042 relative to the translation start site, were subcloned in pBSK (Stratagene), resulting in pGTDC 1 and pGTDC2, respectively. pGTDC2-stop was derived from pGTDC2 by filling in and religating an AvrII site at nt 10541 of cosmid K01C8. pGTDC 1 (nEx1105) was injected at 50 ng/μL and pGTDC2 (nExll80) and pGTDC2-stop (nEx1181) were injected at 2.5 ng/μL into tdc-1(n3420); lin-15(n765ts) animals along with the lin-15 rescuing plasmid. The tbh-1::gfp extrachromosomal transgene was integrated by irradiating transgenic animals with gamma rays.

HPLC Analysis, Thin Layer Chromatography and Decarboxylase Activity Assays

Quantification of octopamine was performed using HPLC coupled with electrochemical detection. 30 μL of packed worms were homogenized with a pestle in 100 μL 0.3 M perchloric acid and centrifuged at 13,000 rpm at 4° C. to remove the insoluble residue. The supernatant was filtered through a 0.22 μm centrifugal filter and diluted five-fold with DEMO mobile phase (ESA, Bedford, Mass., USA), which contains 90 mM sodium phosphate, 50 mM citric acid, 1.7 mM 1-octanesulfonic acid, 10% acetonitrile adjusted to pH 3.0 with phosphoric acid. Samples were injected into an ESA MD 1 50/RP-C18 column at a flow rate of 0.5 mL/minute. Eluted compounds were detected electrochemically using an ESA model 5011 detection system. Detector potentials were set at −175 mV (channel 1), 175 mV (channel 2), 350 mV (channel 3), and 650 mV (channel 4). Under these conditions octopamine was oxidized at 650 mV. Octopamine levels were quantified using 2 pmol external octopamine standards (Sigma), and samples were spiked with octopamine to confirm the identity of the oxidizable substances.

Thin layer chromatography was performed as described (Eaton et al., Anal. Biochem. 172:484 (1988)) with slight modifications. 150 μL of packed worms were homogenized in 300 μL 0.1 M perchloric acid by sonication. Homogenate was centrifuged at 10,000 g for 30 minutes and the supernatant was used for dansylation. 750 μL of 1.2 M bicarbonate buffer pH 9.0 and 2.1 mL dansyl chloride in acetone (0.53 mg/mL) were added to the supernatant, mixed thoroughly and incubated for 20 minutes at 40° C. 300 μL 0.1 M proline was added, mixed thoroughly and incubated for an additional 20 minutes at 40° C. to remove excess dansyl chloride. A stream of dry nitrogen was directed over the reaction mixture to remove excess acetone. Dansylated amines were extracted with three 750 μL volumes of toluene and dried under a stream of dry nitrogen. Dansylated amines were resuspended in 10 μL of toluene, spotted on 10×10 cm Silica gel 60 plates (Sigma-Aldrich) and separated by chloroform: butyl acetate: ethyl acetate (3:3:1) in the first dimension and chloroform: butyl acetate: ethyl acetate: triethylamine (6:1:2:0.5) in the second dimension. Chromatographs were photographed under UV light. 50 pmol of dansylated tyramine, octopamine and dopamine were used as standards.

Immunohistochemistry and Microscopy

TBH-1 antibodies were raised in rabbits against a GST-TBH-1 (a.a. 244-586) fusion protein. TDC-1 antibodies were raised in rabbits against a GST-TDC-1A (a.a. 534-650) fusion protein. TBH-1 and TDC-1 antibodies were purified and used for western blot analysis and immunohistochemistry using standard methods. Identifications of TDC-1 and TBH-1 expressing cells were based on cell body positions and axon morphologies of strains that expressed tbc-1 and tbh-1 g-reporter genes and by immuno-staining. Cell ablations using laser microsurgery ablations were performed durig the second larval stage (L2) as previously described (Avery et al., Neuron 3:473-485 (1989)). GFP reporters were used to facilitate the cell identification and to confirm cell ablation at the L4 stage. The integrated tbh-1::gfp transgenic line, nIs107, was used for RIC ablations. An integrated nmr-1::gfp transgenic line, akIs3, (Brockie et al., Neuron 31, 617-630 (2001)) was used for RIM, AVA, AVD and AVE ablations.

Behavioral Assays

Behavioral assays were performed with young adults at room temperature (22-24° C.) and the different genotypes were scored in parallel on independent days. Egg-laying assays were performed as described by Koelle and Horvitz (Cell 84:115 (1996)). Suppression of head oscillations was tested by striking animals that were outside the bacterial lawn with a fine eyelash behind the posterior bulb of the pharynx; head oscillations were scored during backing response. Nose touch, osmotic avoidance touch were tested as previously described (see, for example, Way et al., Genes Dev. 3:1823-1833 (1989); or Bargmann et al., Cold Spring Harb. Symp. Quant. Biol. 55:529-538 (1990)). Response to harsh touch can only be assayed in animals that do not have functional light-touch sensory neurons and were scored in mec-7(e1527) mutants. Animals were tested twenty-four hours after they were picked as late L4. Laser-ablated animals were tested at least ten times. Animals that did not display any head oscillations during backward locomotion were scored as positive. Laser ablated animals were tested at least 20 times. Reversal assays were performed as described by Tsalik et al., J. Neurobiol. 56:178-197 (2003).
Synthesis of 4-hydrazinomethyl-benzene-1,3-diol (compound 1).

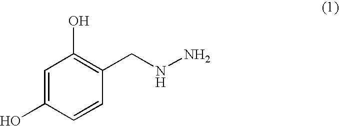

Hydrazine (115 μL, 3.62 mmol) and Pd/C (500 mg) were added to a dry 100 mL round bottom flask and suspended in 5 mL dry methanol. The flask was placed under hydrogen atmosphere using a balloon filled with hydrogen. 2,4-dihydroxybezaldehyde (Aldrich Cat. No. 168637) (500 mg, 3.62 mmol) was dissolved in dry methanol (2 mL) and added dropwise via syringe to the stirring hydrazine suspension. The reaction was allowed to proceed for 16 hours at room temperature. The reaction mixture was filtered through celite and concentrated to yield the crude product (586 mg). Reverse phase HPLC analysis (0-50% acetonitrile in 0.1% aqueous TFA, C18 column) revealed approximately 70% of the desired product, 4-hydrazinomethyl-benzene-1,3-diol, and 30% of the dimer (see Scheme 1) ([M+H]+: 155.07 exp.; 155.12 obsv.). The crude product was used without further purification. 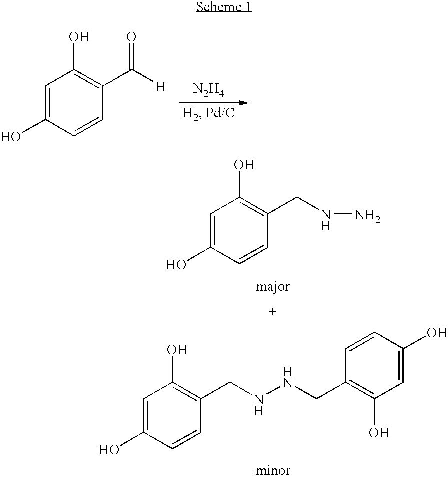
Synthesis of N-(DL-seryl)-N′-(2,4,-dihydroxybenzyl) hydrazine (compound 2).

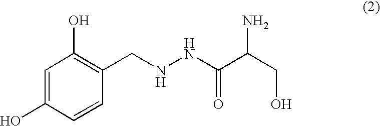

Commercially available N-Boc-Serine-(O-tBu)-OH (Novabiochem) was condensed with 4-hydrazinomethyl-benzene-1,3-diol under standard peptide conditions (see Scheme 2). The hydrazinomethylbenzene (226 mg, 1.5 mmol) and the protected serine (800 mg, 1.8 mmol) were dissolved in methylene chloride (2 mL). To this mixture were added standard peptide coupling reagenets PyBop, HOBt and triethylamine (1.8 mmol each). The reaction was stirred for 3 hours at room temperature, concentrated, redissolved in methanol, and purified by preparative HPLC (10-60% acetonitrile in 0.1% aqueous TFA, C18 column). ([M+H]+: 398.22 exp.; 398.30 obsv.).

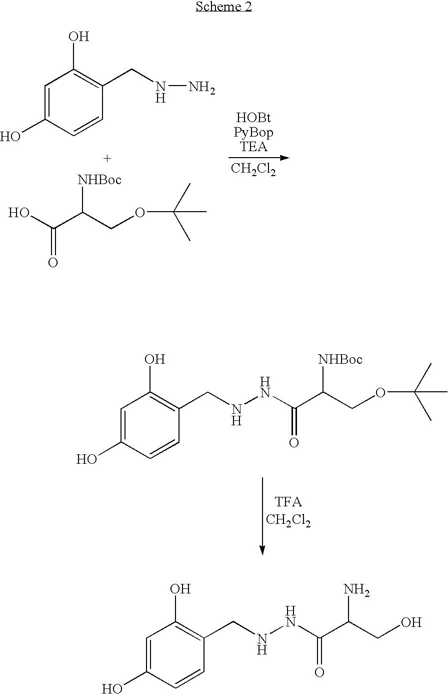

The purified, protected product was dissolved in a 1:1 mixture of CH₂Cl₂:trifluoroacetic acid (1 mL) and allowed to stir at room temperature for 1 hour. The reaction was then concentrated, dissolved in water and purified by preparative HPLC.
Synthesis of (2S)-2-(3-hydroxybenzyl)-2-hydrazinopropanoic acid (compound 3).

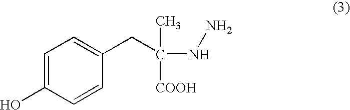

Compound 3 can be synthesized, for example, from α-methyl tyrosine (Sigma Cat. No. M8131), hydrazine O-sulfonic acid, and hydroxylamine O-sulfonic acid using the methods described in Example 23 of U.S. Pat. No. 3,462,536.

Tyrosine Decarboxylase Inhibition Assay.

The screening of putative tyrosine decarboxylase inhibitors can be performed in vitro. For example, recombinant TDC-1, or worm protein extracts, can be combined with the test compound and the conversion rate of [³H]tyrosine to [³H]tyramine measured. A reduction of the conversion rate in the presence of the test compound is indicative of tyrosine decarboxylase inhibition.

Alternatively, putative tyrosine decarboxylase inhibitors can be screened in vivo by observing its effect on invertebrates. Test compounds which possess tyrosine decarboxylase inhibition activity are expected to alter invertebrate behavior, e.g., nematodes may fail to suppress head oscillations in response to anterior touch or may increase reversal frequency. Furthermore, a tyrosine decarboxylase inhibitor is expected to cause egg laying defects in nematodes, fruit flies, and other invertebrates.

TDC activity was assayed as described by McClung and Hirsh (Curr. Biol. 9:853 (1999)) with some modifications. 80 μL of packed worm were frozen in liquid nitrogen. Worms were thawed on ice after adding an equal volume of 50 mM Tris pH 7.5, 1 mM phenylthiourea, homogenized by sonication (10 seconds, 50% duty cycle) in a 1.5 ml tube, and centrifuged for 5 minutes at 13000 rpm. 8 μL of the supernatant was added to 32 μL of reaction buffer (0.1 M NaPO4 pH 6.8, 0.1 mM pyridoxal phosphate, 0.1 mM EDTA, 1 mM β-mercaptoethanol, 40 μCi/ml [³H]tyrosine) and incubated at 25° C. for 0, 30, 60, and 90 minutes. Heat-inactivated protein extract served as a negative control. Tyramine was extracted by adding 100 μL chloroform containing 0.1 M diethyl-hexylphosphoric acid and 300 μL 0.05 M NaPO4 pH 6.8. Samples were vortexed then centrifuged to separate the water phase, containing tyrosine, and the organic phase, containing tyramine. The organic phase was transferred to a new tube and washed once with 300 μL 0.05 M NaPO4 pH 6.8. The organic phase was transferred to a scintillation vial and counted in scintilation fluid.

When compound 2 was added to C. elegans grown on agar plates at a concentration of 0.3 mg/ml, the nematodes fail to suppress head oscillations in response to anterior touch. This change in behavior is consistent with strong inhibition of tyrosine decarboxylase by compound 2 (e.g., consistent with the behavior of C. elegans mutants which lack tyrosine decarboxylase).

The in vivo response test can also be used to determine the dose-response curve for a particular compound and particular invertebrate. From the dose-response curve, a minimum efficacious dose for inhibiting the proliferation of the invertebrate can be calculated.

Antibodies

TBH-1 antibodies were purified against a his-tagged TBH-1 (a.a. 183-586) fusion protein. TDC-1 antibodies were purified against a GST-TDC-1A (a.a. 534-650) fusion protein. TBH-1 and TDC-1 antibodies were used for western blot analyses and immunohistochemistry using standard methods. 1:2000 dilutions of TBH-1 and TDC-1 antibodies were used for western blot analysis. For whole-mount staining, animals were fixed in Bouin's fixative as described (Nonet et al., 1997). Fixed animals were incubated overnight with TBH-1, TDC-1 or GFP antibodies at 1:50 dilution, and incubated for 2 hrs with secondary FITC or Cy3 conjugated antibodies at 1:50 dilution from Jackson ImmunoResearch. GFP monoclonal antibodies were obtained from Chemicon International. Animals were mounted and analyzed with a Zeiss Axioplan microscope equipped with Nomarski optics and a fluorescent light source.

### Other Embodiments

From the foregoing description, it will be apparent that variations and modifications may be made to the invention described herein to adapt it to various usages and conditions. Such embodiments are also within the scope of the following claims.

All publications mentioned in this specification are herein incorporated by reference to the same extent as if each independent publication was specifically and individually indicated to be incorporated by reference.

1. A method of inhibiting proliferation of an insect at a site by contacting said site with a tyrosine decarboxylase inhibitor in an amount sufficient to inhibit said proliferation.

2. The method of claim 1, wherein said site is on a plant.

3. The method of claim 1, wherein said site is on an animal.

4. The method of claim 1, wherein said site is a dwelling.

5. The method of claim 1, wherein said insect is a beetle, grasshopper, locust, wasp, bee, mosquito, fly, midge, ant, cotton leaf perforator, flea, roach, termite, aphid, scale, mite, or moth.

6. The method of claim 1, wherein said tyrosine decarboxylase inhibitor is a compound of formula I: 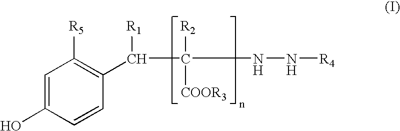
wherein n is 0 or 1; each of R₁, R₂, and R₃ is, independently, selected from H, C₁₋₄ alkyl, C₂₋₄ alkenyl, C₂₋₄ alkynyl, and C₁₋₄ heteroalkyl; R₄ is selected from H and acyl; and R₅ is H, F, or OH.

7. A method of inhibiting proliferation of an invertebrate at a site by contacting said site with a tyrosine decarboxylase inhibitor in an amount sufficient to inhibit said proliferation, wherein said inhibitor is a compound of formula I: 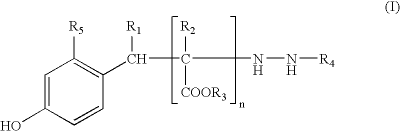
wherein n is 0 or 1; each of R₁, R₂, and R₃ is, independently, selected from H, C₁₋₄ alkyl, C₂₋₄ alkenyl, C₂₋₄ alkynyl, and C₁₋₄ heteroalkyl; R4 is selected from H and acyl; and R₅ is H, F, or OH.

8. The method of claims 1 or 7, wherein said tyrosine decarboxylase inhibitor is (2S)-2-(3-hydroxybenzyl)-2-hydrazinopropanoic acid or N-(DL-seryl)-N′-(2,4,-dihydroxybenzyl) hydrazine or 4-hydrazinomethyl-benzene-1,3-diol.

9. A compound of formula I: 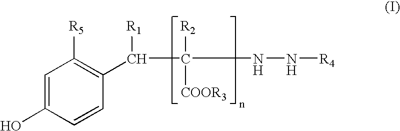
wherein n is 0 or 1; each of R₁, R₂, and R₃ is, independently, selected from H, C₁₋₄ alkyl, C₂₋₄ alkenyl, C₂₋₄ alkynyl, and C₁₋₄ heteroalkyl; R4 is selected from H and acyl; and R₅ is H, F, or OH.

10. The compound of claim 9, wherein said compound is N-(DL-seryl)-N′-(2,4,-dihydroxybenzyl) hydrazine or 4-hydrazinomethyl-benzene-1,3-diol.

11. The compound of claim 9, wherein said compound is (2S)-2-(3-hydroxybenzyl)-2-hydrazinopropanoic acid.

12. A method for identifying an inhibitor of invertebrate tyrosine decarboxylase, said method comprising the steps of:
i. contacting invertebrate tyrosine decarboxylase with tyrosine in the presence of a candidate compound; and
ii. monitoring the conversion of tyrosine to tyramine.

13. The method of claim 12, wherein said tyrosine is radiolabeled.

14. A composition for inhibiting the proliferation of invertebrates comprising a compound of claim 9, or a salt thereof, together with a diluent or dispersant.

15. The composition of claim 14, wherein said formulation is in the form of a spray, dust, granular material, a suspension, emulsion, pellet, or wettable powder.

16. A kit comprising (i) a compound of claim 9, or a salt thereof, and (ii) instructions for delivering said compound to a site infested, or at risk of infestation, by an invertebrate population.

17. A pharmaceutical composition comprising a compound of claim 9 or a salt thereof, together with a pharmaceutically acceptable excipient.

18. The composition of claims 14, 16, or 17, wherein said compound is N-(DL-seryl)-N′-(2,4,-dihydroxybenzyl) hydrazine or 4-hydrazinomethyl-benzene-1,3-diol.

19. The composition of claim 14, 16, or 17, wherein said compound is (2S)-2-(3-hydroxybenzyl)-2-hydrazinopropanoic acid.
